(19) United States
(12) Patent Application Publication
(10) Pub. No.: US 2026/0029871 A1
(43) Pub. Date: Jan. 29, 2026

(54) ELECTRONIC DEVICE AND ELECTRONIC DEVICE DRIVING METHOD

(71) Applicant: Samsung Display Co., Ltd., Yongin-si (KR)

(72) Inventors: KYOUNGHUN BEEN, Yongin-si (KR); MI-HEE SON, Yongin-si (KR); HYOJIN LEE, Yongin-si (KR); JOO-HYEON JEONG, Yongin-si (KR)

(21) Appl. No.: 19/205,888

(22) Filed: May 12, 2025

(30) Foreign Application Priority Data
Jul. 23, 2024 (KR) 10-2024-0097039

(51) Int. Cl. G06F 3/041; G06F 3/044; G09G 3/20; G09G 3/3225

(52) U.S. Cl. CPC G06F 3/04166; G06F 3/04162; G06F 3/04182; G09G 3/2092; G06F 3/0443; G06F 2203/04106; G09G 3/3225; G09G 2310/061; G09G 2310/08; G09G 2354/00

(57) ABSTRACT

An electronic device includes a display layer configured to display an image, a sensor layer on the display layer configured to receive a downlink signal from an input device, a display driver configured to drive the display layer and a sensor driver configured to control the sensor layer and operate in a first mode and a second mode. In the first mode, the display driver is configured to drive the display layer in a first frame having a first operating frequency. In the second mode, the display driver is configured to drive the display layer in a second frame having a second operating frequency lower than the first operating frequency. The second frame includes a first write period and a first blank period. In the second mode, the sensor driver is configured to receive the downlink signal during a period overlapping with the first blank period.

### CROSS-REFERENCE TO RELATED APPLICATION

The present application claims priority to and the benefit of Korean Patent Application No. 10-2024-0097039, filed on Jul. 23, 2024, in the Korean Intellectual Property Office, the entire disclosure of which is incorporated herein by reference.

### BACKGROUND

### 1. Field

Aspects of embodiments of the present disclosure described herein relate to an electronic device with improved sensing reliability, and a method for driving the electronic device.

### 2. Description of the Related Art

An electronic device may sense an external input applied from the outside of the electronic device. The external input may be a user input. The user input may include various types of external inputs such as a part of a user body, light, heat, a pen, or pressure. The electronic device may recognize coordinates of a pen in an electromagnetic resonance (EMR) scheme or an active electrostatic (AES) scheme.

The above information disclosed in this Background section is only for enhancement of understanding of the background of the invention and therefore it may contain information that does not form the prior art.

### SUMMARY

Aspects of some embodiments of the present disclosure are directed to an electronic device having improved sensing reliability, and a method for driving the electronic device.

According to some embodiments of the present disclosure, there is provided an electronic device including: a display layer configured to display an image; a sensor layer on the display layer and configured to receive a downlink signal from an input device; a display driver configured to drive the display layer; and a sensor driver configured to control the sensor layer and to operate in a first mode and a second mode different from the first mode. In the first mode, the display driver is configured to drive the display layer in a first frame having a first operating frequency. In the second mode, the display driver is configured to drive the display layer in a second frame having a second operating frequency lower than the first operating frequency. The second frame includes a first write period and a first blank period, and in the second mode, the sensor driver is configured to receive the downlink signal during a period overlapping with the first blank period.

In some embodiments, in response to the sensor layer sensing a noise signal, the sensor driver may be configured to operate in the second mode.

In some embodiments, in response to receiving a signal from the sensor layer having a frequency about the same as the downlink signal and a magnitude exceeding a set magnitude, the sensor driver may be configured to identify the signal as the noise signal.

In some embodiments, the sensor layer may be configured to sense coordinates of an input by the input device through the downlink signal.

In some embodiments, the input device may be an active pen.

In some embodiments, the display driver may be configured to provide a data voltage to the display layer during the first write period.

In some embodiments, the display driver may be configured to generate a vertical synchronization signal, and in the second mode, the sensor driver may be configured to operate in synchronization with the display driver based on the vertical synchronization signal.

In some embodiments, in the second mode, the display driver may further be configured to drive the display layer in a third frame having a third operating frequency lower than the second operating frequency.

In some embodiments, in the second mode, the display driver may be configured to drive the display layer in the third frame in response to the image being a still image, and the display driver may be configured to drive the display layer in the second frame in response to the image being a video.

In some embodiments, the sensor driver may be configured to compare uniformity between the downlink signal received during a first period and the downlink signal received during a second period continuous with the first period, and may be configured to sense an input by the input device based on another downlink signal received during a third period continuous with the second period in response to the uniformity of the downlink signal received during the first period being different from the uniformity of the downlink signal received during the second period, and the third period may overlap with the first blank period.

According to some embodiments of the present disclosure, there is provided a method of driving an electronic device, the method including: providing the electronic device including a display layer configured to display an image, a sensor layer configured to receive a downlink signal from an input device, a display driver configured to drive the display layer, and a sensor driver configured to drive the sensor layer; determining, by the sensor driver, whether a signal received from the sensor layer is a noise signal that has a same frequency as the downlink signal and has a magnitude exceeding a set magnitude; operating, by the sensor driver, in a first mode in response to the signal being not the noise signal; and operating, by the sensor driver, in a second mode in response to the signal being the noise signal. The operating, by the sensor driver, in the first mode includes: driving, by the display driver, the display layer in a first frame having a first operating frequency. The operating, by the sensor driver, in the second mode includes: driving, by the display driver, the display layer in a second frame, which has a second operating frequency lower than the first operating frequency and which includes a first write period and a first blank period; and receiving, by the sensor driver, the downlink signal during a period overlapping with the first blank period.

In some embodiments, the operating, by the sensor driver, in the second mode may include: sensing, by the sensor layer, coordinates of an input by the input device through the downlink signal.

In some embodiments, the input device may be an active pen.

In some embodiments, the display driver may be configured to generate a vertical synchronization signal.

In some embodiments, the operating, by the sensor driver, in the second mode may further include: operating, by the sensor driver, in synchronization with the display driver based on the vertical synchronization signal.

In some embodiments, the operating, by the sensor driver, in the second mode may further include driving, by the display driver, the display layer in a third frame having a third operating frequency lower than the second operating frequency.

In some embodiments, the operating, by the sensor driver, in the second mode may further include: determining whether the image is a still image or a video.

In some embodiments, the operating, by the sensor driver, in the second mode may further include: in response to the image being the still image, driving, by the display driver, the display layer in the third frame; and in response to the image being the video, driving, by the display driver, the display layer in the second frame. In some embodiments, the operating, by the sensor driver, in the second mode may further include: comparing, by the sensor driver, uniformity between the downlink signal received during a first period and the downlink signal received during a second period continuous with the first period.

In some embodiments, the operating, by the sensor driver, in the second mode may further include: sensing an input by the input device based on another downlink signal received during a third period continuous with the second period in response to the uniformity of the downlink signal received during the first period being different from the uniformity of the downlink signal received during the second period, and the third period may overlap with the first blank period.

### BRIEF DESCRIPTION OF THE DRAWINGS

The above and other objects and features of the present disclosure will become apparent by describing in detail embodiments thereof with reference to the accompanying drawings.

FIG. 1 is a perspective view illustrating an interface device, according to one or more embodiments of the present disclosure.

FIG. 2 is a perspective view illustrating an interface device, according to one or more embodiments of the present disclosure.

FIG. 3 is a block diagram schematically illustrating an electronic device and an input device, according to one or more embodiments of the present disclosure.

FIG. 4A is a cross-sectional view of an electronic device, according to one or more embodiments of the present disclosure.

FIG. 4B is a cross-sectional view of an electronic device, according to one or more embodiments of the present disclosure.

FIG. 5 is a cross-sectional view of an electronic device, according to one or more embodiments of the present disclosure.

FIG. 6 is a block diagram of a display layer and a display driver, according to one or more embodiments of the present disclosure.

FIG. 7 is a block diagram of a sensor layer and a sensor driver, according to one or more embodiments of the present disclosure.

FIG. 8 is a flowchart illustrating a method of driving an electronic device, according to one or more embodiments of the present disclosure.

FIG. 9 is a diagram illustrating operations of a display driver and a sensor driver in a first mode, according to one or more embodiments of the present disclosure.

FIG. 10A is a diagram illustrating operations of a sensor layer and a sensor driver in a first sensing period, according to one or more embodiments of the present disclosure.

FIG. 10B is a diagram illustrating operations of a sensor layer and a sensor driver in a second sensing period, according to one or more embodiments of the present disclosure.

FIG. 10C is a diagram illustrating operations of a sensor layer and a sensor driver in a third sensing period, according to one or more embodiments of the present disclosure.

FIG. 11 is a flowchart illustrating a method of driving an electronic device in a second mode, according to one or more embodiments of the present disclosure.

FIG. 12 is a diagram illustrating operations of a display driver and a sensor driver in a second mode, according to one or more embodiments of the present disclosure.

FIG. 13 is a diagram illustrating operations of a display driver and a sensor driver in a second mode, according to one or more embodiments of the present disclosure.

FIG. 14A is a graph showing a signal magnitude according to a pen location, according to one or more embodiments of the present disclosure.

FIG. 14B is a graph showing a signal magnitude according to a pen location, according to a comparative example of the present disclosure.

FIG. 15A is a graph showing a signal magnitude according to a pen location, according to one or more embodiments of the present disclosure.

FIG. 15B is a graph showing a signal magnitude according to a pen location, according to one or more embodiments of the present disclosure.

FIG. 16 is a flowchart illustrating a method of driving an electronic device in a second mode, according to one or more embodiments of the present disclosure.

FIG. 17 is a diagram illustrating operations of a display driver and a sensor driver in a second mode, according to one or more embodiments of the present disclosure.

FIG. 18 is a flowchart illustrating a method of driving an electronic device in a second mode, according to one or more embodiments of the present disclosure.

FIG. 19 is a diagram illustrating operations of a display driver and a sensor driver in a second mode, according to one or more embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

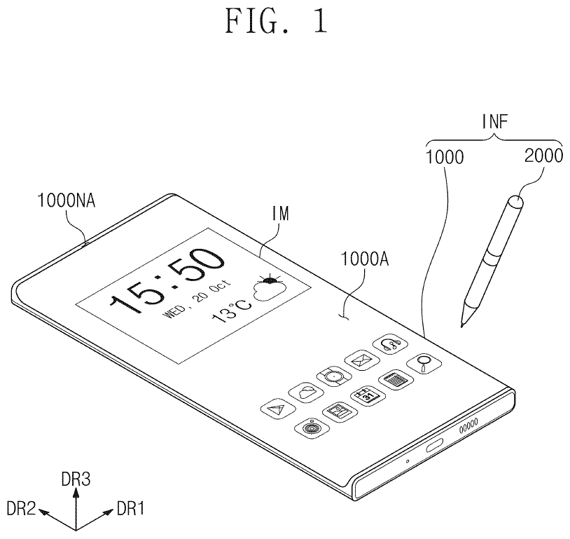

FIG. 1 is a perspective view illustrating an interface device, according to one or more embodiments of the present disclosure.

Referring to FIG. 1, an interface device INF may include an electronic device 1000 and an input device 2000.

The electronic device 1000 may be a device activated depending on an electrical signal. For example, the electronic device 1000 may be a mobile phone, a tablet, a car navigation system, a game console, or a wearable device, but is not limited thereto. FIG. 1 illustrates that the electronic device 1000 is a mobile phone.

An active area 1000A and a peripheral area 1000NA may be defined in the electronic device 1000. The electronic device 1000 may display an image through the active area 1000A. The active area 1000A may include a surface defined by a first direction DR1 and a second direction DR2 crossing the first direction DR1. The peripheral area 1000NA may surround at least a portion of the peripheral area of the active area 1000A.

A thickness direction of the electronic device 1000 may be parallel to a third direction DR3 (e.g., a thickness direction) intersecting the first direction DR1 and the second direction DR2. Accordingly, front surfaces (or upper surfaces) and back surfaces (or lower surfaces) of members constituting the electronic device 1000 may be defined based on the third direction DR3.

The electronic device 1000 may display an image IM in the third direction DR3. The image IM may include a still image or a moving image. In FIG. 1, a clock and icons are illustrated as an example of the image IM.

The electronic device 1000 may detect inputs applied from the outside of the electronic device 1000. The inputs applied from the outside may include various suitable kinds of external inputs, such as a portion of a user's body, light, heat, pressure, or the like. The inputs applied from the outside may be referred to as a “first input”.

The electronic device 1000 illustrated in FIG. 1 may detect an input by the user's touch and an input by the input device 2000. The input device 2000 may refer to a device other than the user's body. The input by the input device 2000 may be referred to as a “second input”. For example, the input device 2000 may be an active pen, a stylus pen, a touch pen, an electronic pen, or the like.

The electronic device 1000 and the input device 2000 may be capable of bidirectional communication. The electronic device 1000 may provide an uplink signal to the input device 2000. For example, the uplink signal may include a synchronization signal or information of the electronic device 1000, but is not particularly limited thereto. The input device 2000 may provide a downlink signal to the electronic device 1000. The downlink signal may include state information of the input device 2000 or a synchronization signal.

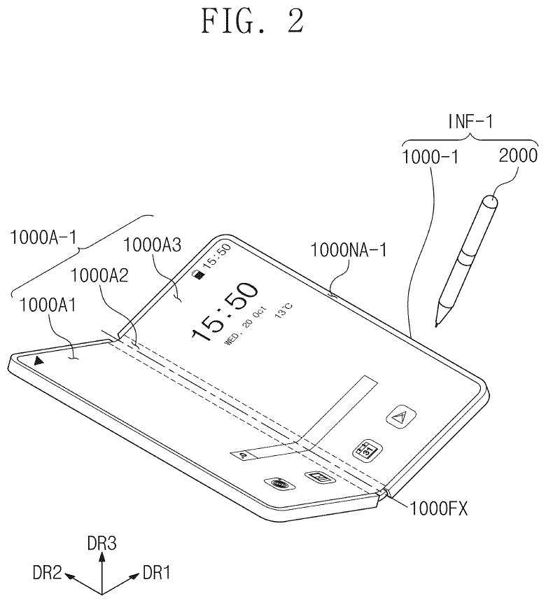

FIG. 2 is a perspective view illustrating an interface device, according to one or more embodiments of the present disclosure. In the description of FIG. 2, the same reference numerals are assigned to the same components described with reference to FIG. 1, and thus the descriptions thereof are omitted to avoid redundancy.

Referring to FIG. 2, an electronic device 1000-1 may display an image through an active area 1000A-1. In FIG. 2, it is illustrated that the electronic device 1000-1 is folded at a set angle (e.g., a preset or predetermined angle). The active area 1000A-1 may include a plane defined by the first direction DR1 and the second direction DR2, in a state where the electronic device 1000-1 is unfolded.

The active area 1000A-1 may include a first area 1000A1, a second area 1000A2, and a third area 1000A3. The first area 1000A1, the second area 1000A2, and the third area 1000A3 may be sequentially defined in the first direction DR1. The second area 1000A2 may be bent about a folding axis 1000FX extending in the second direction DR2. Accordingly, the first area 1000A1 and the third area 1000A3 may be referred to as “non-folding areas”, and the second area 1000A2 may be referred to as a “folding area”.

In a state wherein the electronic device 1000-1 is folded, the first area 1000A1 and the third area 1000A3 may face each other. Accordingly, while the electronic device 1000-1 is fully folded, the active area 1000A-1 may not be exposed to the outside, which may be referred to as “in-folding”. However, this is an example. For example, an operation of the electronic device 1000-1 is not limited thereto.

For example, according to one or more embodiments of the present disclosure, in a state wherein the electronic device 1000-1 is folded, the first area 1000A1 and the third area 1000A3 may be opposed to each other. Accordingly, in a state where the electronic device 1000-1 is folded, the active area 1000A-1 may be exposed to the outside, which may be referred to as “out-folding”.

The electronic device 1000-1 may perform only one of an in-folding operation or an out-folding operation. In one or more embodiments, the electronic device 1000-1 may perform both an in-folding operation and an out-folding operation. In this case, the same area of the electronic device 1000-1, for example, the second area 1000A2 may be in-folded and out-folded.

One folding area and two non-folding areas are illustrated in FIG. 2, but the number of folding areas and the number of non-folding areas are not limited thereto. For example, the electronic device 1000-1 may include a plurality of non-folding areas, of which the number is greater than two, and a plurality of folding areas interposed between non-folding areas adjacent to one another.

FIG. 2 illustrates that the folding axis 1000FX extends in the second direction DR2, but the present disclosure is not limited thereto. For example, the folding axis 1000FX may extend in a direction parallel to the first direction DR1. In this case, the first area 1000A1, the second area 1000A2, and the third area 1000A3 may be sequentially arranged in the second direction DR2.

The active area 1000A-1 may overlap with at least one or more electronic modules. For example, the electronic modules may include a camera module, a proximity illuminance sensor, and the like. The electronic modules may receive an external input delivered through the active area 1000A-1 or may provide an output through the active area 1000A-1. A part of the active area 1000A-1 that overlaps with the camera module, the proximity illuminance sensor, and the like may have a higher transmittance than the other parts of the active area 1000A-1. Accordingly, there is no need to provide an area, in which a plurality of electronic modules are to be arranged, to a peripheral area 1000NA-1 around the active area 1000A-1. As a result, an area ratio of the active area 1000A-1 to the front surface of the electronic device 1000-1 may be increased.

The electronic device 1000-1 and the input device 2000 may be capable of bidirectional communication. The electronic device 1000-1 may provide an uplink signal to the input device 2000. The input device 2000 may provide a downlink signal to the electronic device 1000-1. The electronic device 1000-1 may detect coordinates of the input device 2000 by using a signal provided from the input device 2000.

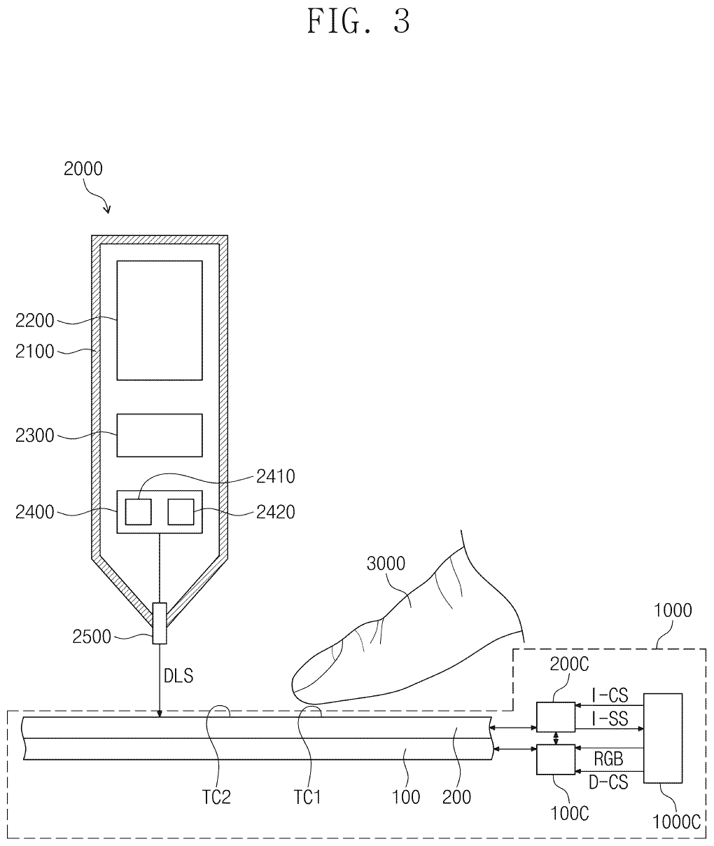

FIG. 3 is a block diagram schematically illustrating an electronic device and an input device, according to one or more embodiments of the present disclosure.

Referring to FIG. 3, the electronic device 1000 may include a display layer 100, a sensor layer 200, a display driver 100C, a sensor driver 200C, and a main controller 1000C.

The display layer 100 may be a configuration that substantially generates an image. The display layer 100 may be a light-emitting display layer. For example, the display layer 100 may be an organic light-emitting display layer, a quantum dot display layer, a micro-LED display layer, or a nano-LED display layer.

The sensor layer 200 may be disposed on the display layer 100. The sensor layer 200 may sense an external input applied from the outside. The sensor layer 200 may detect a first input TC1 by a user's body 3000 and a second input TC2 by the input device 2000.

The main controller 1000C may control overall operations of the electronic device 1000. For example, the main controller 1000C may control operations of the display driver 100C and the sensor driver 200C. The main controller 1000C may include at least one microprocessor, and the main controller 1000C may be referred to as a “host”.

The display driver 100C may control the display layer 100. The main controller 1000C may further include a graphic controller. The display driver 100C may receive image data RGB and a control signal D-CS from the main controller 1000C. The control signal D-CS may include various signals. For example, the control signal D-CS may include an input vertical synchronization signal, an input horizontal synchronization signal, a main clock, and/or a data enable signal. The display driver 100C may generate a vertical synchronization signal and a horizontal synchronization signal for controlling timing for providing a signal to the display layer 100, based on the control signal D-CS.

The sensor driver 200C may control the sensor layer 200. The sensor driver 200C may receive a control signal I-CS from the main controller 1000C. The control signal I-CS may include a clock signal and mode determination signal for determining a driving mode of the sensor driver 200C. The sensor driver 200C may operate in a first sensing mode for detecting the first input TC1 by the user's body 3000, or in a second sensing mode for detecting the second input TC2 by the input device 2000 based on the control signal I-CS. The sensor driver 200C may control the sensor layer 200 in the first mode or the second mode based on the mode determination signal to be described.

The sensor driver 200C may calculate coordinate information of a first input or a second input based on a signal received from the sensor layer 200 and may provide a coordinate signal I-SS having the coordinate information to the main controller 1000C. The main controller 1000C may execute an operation corresponding to a user input based on the coordinate signal I-SS. For example, the main controller 1000C may operate the display driver 100C such that a new application image is displayed on the display layer 100 based on the coordinate signal I-SS.

The input device 2000 may include housing 2100, a power supply unit 2200, a controller 2300, a communication module 2400, and a pen electrode 2500. However, the components constituting the input device 2000 are not limited to the listed components. For example, the input device 2000 may further include an electrode switch for switching an operating mode to a signal transmission mode or a signal reception mode, a pressure sensor for sensing pressure, a memory for storing predetermined information, or a rotation sensor for sensing rotation.

The housing 2100 may have a pen shape, and an accommodation space may be formed in the housing 2100. The power supply unit 2200, the controller 2300, the communication module 2400, and the pen electrode 2500 may be accommodated in the accommodation space defined inside the housing 2100.

The power supply unit 2200 may supply a power source to the controller 2300 and the communication module 2400 inside the input device 2000. The power supply unit 2200 may include a battery or a high capacity capacitor.

The controller 2300 may control the operation of the input device 2000. The controller 2300 may be an application-specific integrated circuit (ASIC). The controller 2300 may be configured to operate depending on a designed program.

The communication module 2400 may include a transmission circuit 2410 and a reception circuit 2420. The transmission circuit 2410 may output a downlink signal DLS to the sensor layer 200. The reception circuit 2420 may receive an uplink signal provided from the sensor layer 200. The transmission circuit 2410 may receive a signal provided from the controller 2300 and may modulate the signal into a signal capable of being sensed by the sensor layer 200. The reception circuit 2420 may modulate a signal provided from the sensor layer 200 into a signal processable by the controller 2300.

The pen electrode 2500 may be electrically connected to the communication module 2400. A portion of the pen electrode 2500 may protrude from the housing 2100. In one or more embodiments, the input device 2000 may further include cover housing that covers the pen electrode 2500 exposed from the housing 2100. In one or more embodiments, the pen electrode 2500 may be embedded in (e.g., integrated with) the housing 2100.

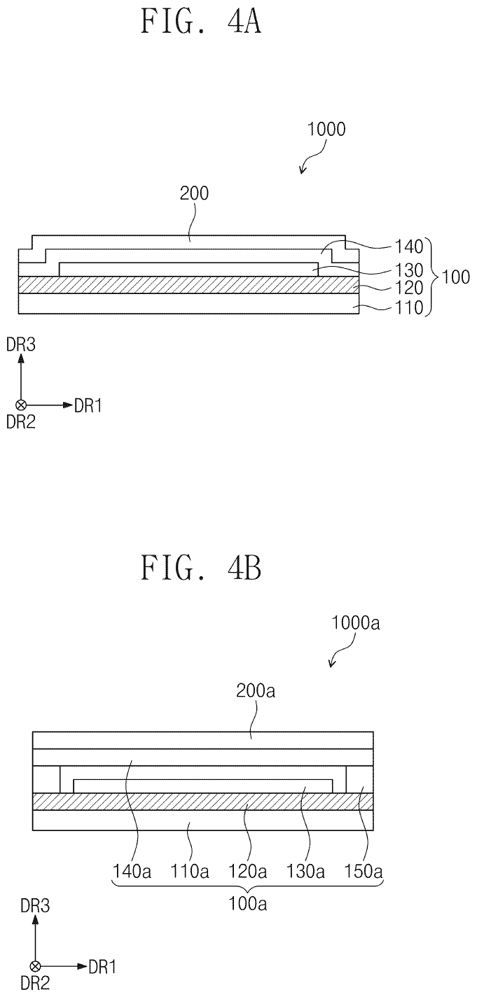

FIG. 4A is a cross-sectional view of an electronic device, according to one or more embodiments of the present disclosure.

Referring to FIG. 4A, the electronic device 1000 may include the display layer 100 and the sensor layer 200. The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may be a glass substrate, a metal substrate, or a polymer substrate. However, the present disclosure is not limited thereto. For example, the base layer 110 may be an inorganic layer, an organic layer, or a composite material layer.

The base layer 110 may have a multi-layer structure. For example, the base layer 110 may include a first synthetic resin layer, a silicon oxide (SiOx) layer disposed on the first synthetic resin layer, an amorphous silicon (a-Si) layer disposed on the silicon oxide layer, and a second synthetic resin layer disposed on the amorphous silicon layer. The silicon oxide layer and the amorphous silicon layer may be referred to as a “base barrier layer”.

Each of the first and second synthetic resin layers may include polyimide-based resin. Also, each of the first and second synthetic resin layers may include at least one of acrylate-based resin, methacrylate-based resin, polyisoprene-based resin, vinyl-based resin, epoxy-based resin, urethane-based resin, cellulose-based resin, siloxane-based resin, polyamide-based resin, and perylene-based resin. “˜˜″-based resin in the specification means including the functional group of” ˜˜″.

The circuit layer 120 may be disposed on the base layer 110. The circuit layer 120 may include an insulating layer, a semiconductor pattern, a conductive pattern, and a signal line. The insulating layer, the semiconductor layer, and the conductive layer may be formed on the base layer 110 in a manner such as coating, evaporation, or the like. Afterward, the insulating layer, the semiconductor layer, and the conductive layer may be selectively patterned by performing a photolithography process multiple times. Afterward, the semiconductor pattern, the conductive pattern, and the signal line included in the circuit layer 120 may be formed.

The light-emitting element layer 130 may be disposed on the circuit layer 120. The light-emitting element layer 130 may include a light-emitting element. For example, the light-emitting element layer 130 may include an organic luminescent material, a quantum dot, a quantum rod, a micro-LED, or a nano-LED.

The encapsulation layer 140 may be disposed on the light-emitting element layer 130. The encapsulation layer 140 may protect the light-emitting element layer 130 from foreign substances, such as moisture, oxygen, and dust particles.

The sensor layer 200 may be formed on the display layer 100 through a successive process. For example, the sensor layer 200 may be expressed as being directly disposed on the display layer 100. “Being directly disposed” may mean that a third component is not interposed between the sensor layer 200 and the display layer 100. That is, a separate adhesive member may not be interposed between the sensor layer 200 and the display layer 100. In one or more embodiments, the sensor layer 200 may be coupled to the display layer 100 through an adhesive member. The adhesive member may include a common adhesive or a common sticking agent.

FIG. 4B is a cross-sectional view of an electronic device, according to one or more embodiments of the present disclosure.

Referring to FIG. 4B, an electronic device 1000a may include a display layer 100a and a sensor layer 200a. The display layer 100a may include a base substrate 110a, a circuit layer 120a, a light-emitting element layer 130a, an encapsulation substrate 140a, and a coupling member 150a.

Each of the base substrate 110a and the encapsulation substrate 140a may be a glass substrate, a metal substrate, a polymer substrate, or the like, but is not particularly limited thereto.

The coupling member 150a may be interposed between the base substrate 110a and the encapsulation substrate 140a. The coupling member 150a may couple the encapsulation substrate 140a to the base substrate 110a or the circuit layer 120a. The coupling member 150a may include an inorganic material or an organic material. For example, the inorganic material may include a frit seal, and the organic material may include a photo-curable resin or a photo-plastic resin. However, the material constituting the coupling member 150a is not limited to the example.

The sensor layer 200a may be directly disposed on the encapsulation substrate 140a. “Being directly disposed” may mean that a third component is not interposed between the sensor layer 200a and the encapsulation substrate 140a. That is, a separate adhesive member may not be interposed between the sensor layer 200a and the display layer 100a. However, the present disclosure is not limited thereto, and an adhesive layer may be further interposed between the sensor layer 200a and the encapsulation substrate 140a.

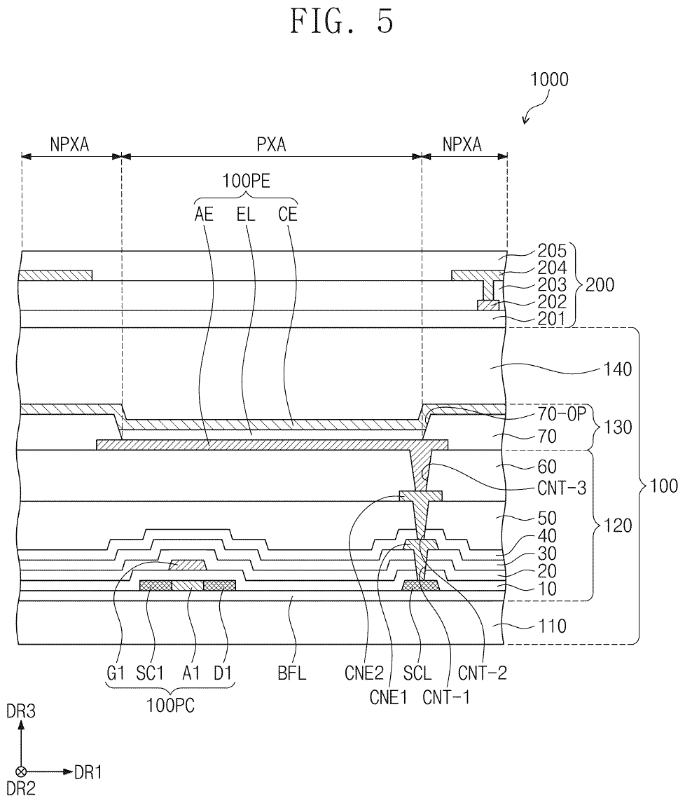

FIG. 5 is a cross-sectional view of an electronic device, according to one or more embodiments of the present disclosure. In the description of FIG. 5, the same reference numerals are assigned to the same components described with reference to FIG. 4A, and thus the descriptions thereof are omitted to avoid redundancy.

Referring to FIG. 5, at least one inorganic layer may be formed on the upper surface of the base layer 110. The inorganic layer may include at least one of aluminum oxide, titanium oxide, silicon oxide, silicon oxynitride, zirconium oxide, and hafnium oxide. The inorganic layer may be formed of multiple layers. The multiple inorganic layers may constitute a barrier layer and/or a buffer layer. In one or more embodiments, the display layer 100 is illustrated as including a buffer layer BFL.

The buffer layer BFL may improve a bonding force between the base layer 110 and a semiconductor pattern. The buffer layer BFL may include a silicon oxide layer and a silicon nitride layer. The silicon oxide layer and the silicon nitride layer may be stacked alternately.

The semiconductor pattern may be disposed on the buffer layer BFL. The semiconductor pattern may include polysilicon. However, the present disclosure is not limited thereto, and the semiconductor pattern may include amorphous silicon, low-temperature polycrystalline silicon, or an oxide semiconductor.

FIG. 5 only illustrates a part of the semiconductor pattern, and the semiconductor pattern may be further disposed in another area. The semiconductor pattern may be arranged in a rule throughout pixels. The semiconductor pattern may have electrical characteristics different depending on whether the semiconductor pattern is doped. The semiconductor pattern may include a first area having high conductivity and a second area having low conductivity. The first area may be doped with an N-type dopant or a P-type dopant. The P-type transistor may include the doped area doped with a P-type dopant, and the N-type transistor may include the doped area doped with an N-type dopant. The second area may be an undoped area or may be doped with a lower concentration than the first area.

The conductivity of the first area may be greater than that of the second area. The first area may substantially operate as an electrode or signal line. The second area may substantially correspond to an active (e.g., a channel) of a transistor. In other words, a part of the semiconductor pattern may be an active of the transistor. Another part thereof may be a source or drain of the transistor. Another part may be a connection electrode or a connection signal line.

Each of the pixels may have an equivalent circuit including seven transistors, one capacitor, and a light-emitting element. The equivalent circuit of a pixel may be modified in various shapes. One transistor 100PC and one light-emitting element 100PE included in a pixel are illustrated in FIG. 5 by way of example.

The transistor 100PC may include a source SC1, an active A1, a drain D1, and a gate G1. The source SC1, the active A1, and the drain D1 may be formed from the semiconductor pattern. The source SC1 and the drain D1 may extend in directions opposite to each other from the active A1 on a cross section. A part of a connection signal line SCL formed from the semiconductor pattern is illustrated in FIG. 5. The connection signal line SCL may be electrically connected to the drain D1 of the transistor 100PC on a plane.

A first insulating layer 10 may be disposed on the buffer layer BFL. The first insulating layer 10 may overlap with a plurality of pixels in common and may cover the semiconductor pattern. The first insulating layer 10 may be an inorganic layer and/or an organic layer, and may have a single-layer structure or a multi-layer structure. The first insulating layer 10 may include at least one of aluminum oxide, titanium oxide, silicon oxide, silicon nitride, silicon oxynitride, zirconium oxide, and hafnium oxide. In one or more embodiments, the first insulating layer 10 may be a single silicon oxide layer. Not only the first insulating layer 10 but also an insulating layer of the circuit layer 120 to be described later may be an inorganic layer and/or an organic layer, and may have a single-layer structure or a multi-layer structure. The inorganic layer may include at least one of the above-described materials, but is not limited thereto.

The gate G1 may be disposed on the first insulating layer 10. The gate G1 may be a part of a metal pattern. The gate G1 may overlap with the active A1. In a process of doping the semiconductor pattern, the gate G1 may act as a mask.

A second insulating layer 20 may be disposed on the first insulating layer 10 and may cover the gate G1. The second insulating layer 20 may overlap with pixels in common. The second insulating layer 20 may be an inorganic layer and/or an organic layer, and may have a single-layer structure or a multi-layer structure. The second insulating layer 20 may include at least one of silicon oxide, silicon nitride, and silicon oxynitride. In one or more embodiments, the second insulating layer 20 may have a multi-layer structure including a silicon oxide layer and a silicon nitride layer.

A third insulating layer 30 may be disposed on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be disposed on the third insulating layer 30. The first connection electrode CNE1 may be connected to the connection signal line SCL through a contact hole CNT-1 penetrating the first, second, and third insulating layers 10, 20, and 30.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light-emitting element layer 130 may be disposed on the circuit layer 120. The light-emitting element layer 130 may include the light-emitting element 100PE. For example, the light-emitting element layer 130 may include an organic luminescent material, a quantum dot, a quantum rod, a micro-LED, or a nano-LED. Hereinafter, the description will be given under the condition that the light-emitting element 100PE is an organic light-emitting element, but the present disclosure is not particularly limited thereto.

The light-emitting element 100PE may include a first electrode AE, a light-emitting layer EL, and a second electrode CE. The first electrode AE may be disposed on the sixth insulating layer 60. The first electrode AE may be connected to the second connection electrode CNE2 through a contact hole CNT-3 penetrating the sixth insulating layer 60.

A pixel defining film 70 may be disposed on the sixth insulating layer 60 and may cover a portion of the first electrode AE. An opening 70-OP may be defined in the pixel defining film 70. The opening 70-OP of the pixel defining film 70 may expose at least part of the first electrode AE.

The active area 1000A (see, e.g., FIG. 1) may include an emission area PXA and a non-emission area NPXA adjacent to the emission area PXA. The non-emission area NPXA may surround the emission area PXA. In one or more embodiments, the emission area PXA is defined to correspond to a partial area of the first electrode AE, which is exposed by the opening 70-OP.

The light-emitting layer EL may be disposed on the first electrode AE. The light-emitting layer EL may be disposed in an area corresponding to the opening 70-OP. That is, the light-emitting layer EL may be separately formed on each of pixels. When the light-emitting layers EL are separately formed in each of pixels, each of the light-emitting layers EL may emit light of at least one of a blue color, a red color, and a green color. However, the present disclosure is not limited thereto. For example, the light-emitting layer EL may be connected and provided to each of the pixels in common. In this case, the light-emitting layer EL may provide blue light or white light.

The second electrode CE may be disposed on the light-emitting layer EL. The second electrode CE may be disposed in a plurality of pixels in common while having an integral shape.

A hole control layer may be interposed between the first electrode AE and the light-emitting layer EL. The hole control layer may be disposed in common in the emission area PXA and the non-emission area NPXA. The hole control layer may include a hole transport layer and may further include a hole injection layer. An electron control layer may be interposed between the light-emitting layer EL and the second electrode CE. The electron control layer may include an electron transport layer, and may further include an electron injection layer. The hole control layer and the electron control layer may be formed in common in a plurality of pixels by using an open mask.

The encapsulation layer 140 may be disposed on the light-emitting element layer 130. The encapsulation layer 140 may include an inorganic layer, an organic layer, and an inorganic layer sequentially stacked, and layers constituting the encapsulation layer 140 are not limited thereto.

The inorganic layers may protect the light-emitting element layer 130 from moisture and oxygen, and the organic layer may protect the light-emitting element layer 130 from a foreign material, such as dust particles. The inorganic layers may include a silicon nitride layer, a silicon oxynitride layer, a silicon oxide layer, a titanium oxide layer, an aluminum oxide layer, or the like. The organic layer may include an acrylate-based organic layer, but is not limited thereto.

The sensor layer 200 may be formed on the display layer 100 through a successive process. In this case, the sensor layer 200 may be directly disposed on the display layer 100. “Being directly disposed” may mean that a third component is not interposed between the sensor layer 200 and the display layer 100. That is, a separate adhesive member may not be interposed between the sensor layer 200 and the display layer 100. In one or more embodiments, the sensor layer 200 may be coupled to the display layer 100 through an adhesive member. The adhesive member may include a typical adhesive or a sticking agent.

The sensor layer 200 may include a base insulating layer 201, a first conductive layer 202, a sensing insulating layer 203, a second conductive layer 204, and a cover insulating layer 205.

The base insulating layer 201 may be an inorganic layer including at least one of silicon nitride, silicon oxynitride, and silicon oxide. In one or more embodiments, the base insulating layer 201 may be an organic layer including an epoxy resin, an acrylate resin, or an imide-based resin. The base insulating layer 201 may have a single-layer structure or may have a multi-layer structure stacked in the third direction DR3.

Each of the first conductive layer 202 and the second conductive layer 204 may have a single-layer structure or may have a multi-layer structure in which layers are stacked in the third direction DR3.

A conductive layer of a single-layer structure may include a metal layer or a transparent conductive layer. The metal layer may include molybdenum, silver, titanium, copper, aluminum, or an alloy thereof. The transparent conductive layer may include a transparent conductive oxide, such as indium tin oxide (ITO), indium zinc oxide (IZO), zinc oxide (ZnO), indium zinc tin oxide (IZTO), or the like. The transparent conductive layer may include a conductive polymer, such as Poly(3,4-ethylenedioxythiophene) (PEDOT), a metal nano wire, graphene, and the like.

A conductive layer of the multi-layer structure may include metal layers. For example, the metal layers may have a three-layer structure of titanium/aluminum/titanium. The conductive layer of the multi-layer structure may include at least one metal layer and at least one transparent conductive layer.

At least one of the sensing insulating layer 203 and the cover insulating layer 205 may include an inorganic film. The inorganic film may include at least one of aluminum oxide, titanium oxide, silicon oxide, silicon nitride, silicon oxynitride, zirconium oxide, and hafnium oxide.

At least one of the sensing insulating layer 203 and the cover insulating layer 205 may include an organic film. The organic film may include at least one of acrylate-based resin, methacrylate-based resin, polyisoprene, vinyl-based resin, epoxy-based resin, urethane-based resin, cellulose-based resin, siloxane-based resin, polyimide-based resin, polyamide-based resin, and perylene-based resin.

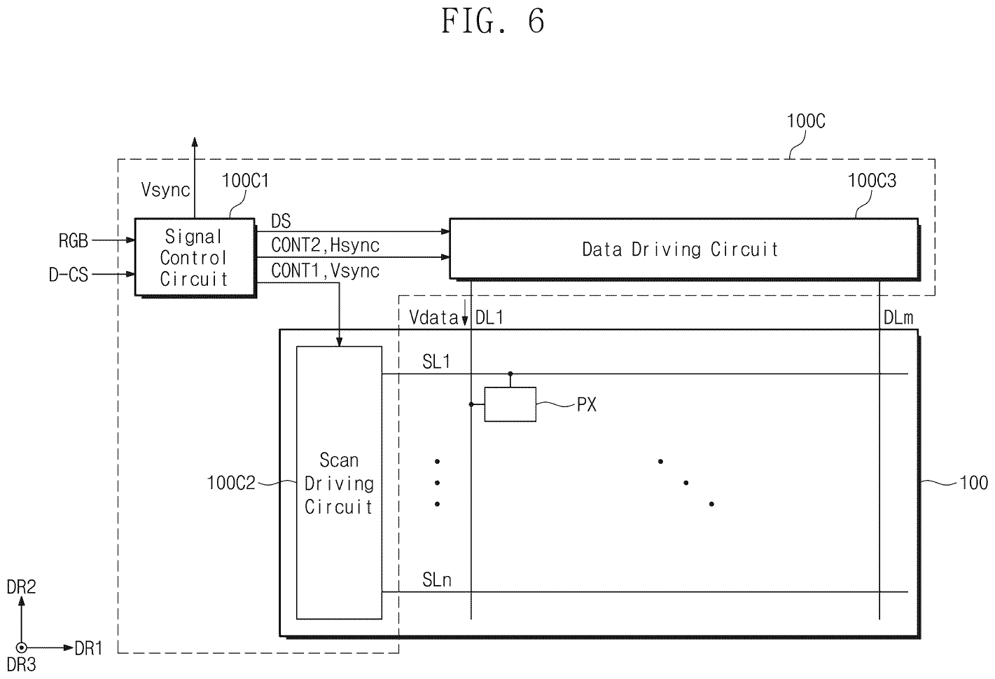

FIG. 6 is a block diagram of a display layer and a display driver, according to one or more embodiments of the present disclosure.

Referring to FIG. 6, the display layer 100 may include a plurality of scan wires SL1 to SLn, a plurality of data wires DL1 to DLm, and a plurality of pixels PX. Each of the plurality of pixels PX may be connected to the corresponding data wire among the plurality of data wires DL1 to DLm and may be connected to the corresponding scan wire among the plurality of scan wires SL1 to SLn. In one or more embodiments of the present disclosure, the display layer 100 may further include light-emitting control wires, and the display driver 100C may further include an emission driving circuit that provides control signals to light-emitting control wires. The configuration of the display layer 100 is not particularly limited thereto.

The display driver 100C may include a signal control circuit 100C1, a scan driving circuit 100C2, and a data driving circuit 100C3.

The signal control circuit 100C1 may receive the image data RGB and the control signal D-CS from the main controller 1000C (see, e.g., FIG. 3). The control signal D-CS may include various signals. For example, the control signal D-CS may include an input vertical synchronization signal, an input horizontal synchronization signal, a main clock, and a data enable signal.

On the basis of the control signal D-CS, the signal control circuit 100C1 may generate a first control signal CONT1 and a vertical synchronization signal Vsync, and may output the first control signal CONT1 and the vertical synchronization signal Vsync to the scan driving circuit 100C2. The vertical synchronization signal Vsync may be included in the first control signal CONT1.

The signal control circuit 100C1 may output the vertical synchronization signal Vsync to the sensor driver 200C to synchronize the driving timing with the sensor layer 200 (see, e.g., FIG. 5).

On the basis of the control signal D-CS, the signal control circuit 100C1 may generate a second control signal CONT2 and a horizontal synchronization signal Hsync, and may output the second control signal CONT2 and the horizontal synchronization signal Hsync to the data driving circuit 100C3. The horizontal synchronization signal Hsync may be included in the second control signal CONT2.

Furthermore, the signal control circuit 100C1 may output, to the data driving circuit 100C3, a data signal DS obtained by processing the image data RGB to be suitable for an operating condition of the display layer 100. The first control signal CONT1 and the second control signal CONT2 are signals for operating the scan driving circuit 100C2 and the data driving circuit 100C3 and are not particularly limited thereto.

The scan driving circuit 100C2 may drive the plurality of scan wires SL1 to SLn in response to the first control signal CONT1 and the vertical synchronization signal Vsync. In one or more embodiments of the present disclosure, the scan driving circuit 100C2 may be formed in the same process as the circuit layer 120 (see, e.g., FIG. 5) in the display layer 100, but is not limited thereto. For example, the scan driving circuit 100C2 may be implemented as an integrated circuit (IC). The scan driving circuit 100C2 may be directly mounted in a set area (e.g., a preset area or a predetermined area) of the display layer 100 or may be mounted on a separate printed circuit board in a chip on film (COF) scheme. The scan driving circuit 100C2 may be electrically connected to the display layer 100.

The data driving circuit 100C3 may output a data voltage Vdata for driving the plurality of data wires DL1 to DLm, in response to the second control signal CONT2, the horizontal synchronization signal Hsync, and the data signal DS from the signal control circuit 100C1. The data driving circuit 100C3 may be implemented with IC. The data driving circuit 100C3 may be directly mounted in a set area (e.g., a preset or predetermined area) of the display layer 100 or may be mounted on a separate printed circuit board in a COF scheme, and then may be electrically connected to the display layer 100, but is not particularly limited thereto. For example, the data driving circuit 100C3 may be formed in the same process as the circuit layer 120 (see, e.g., FIG. 5) in the display layer 100.

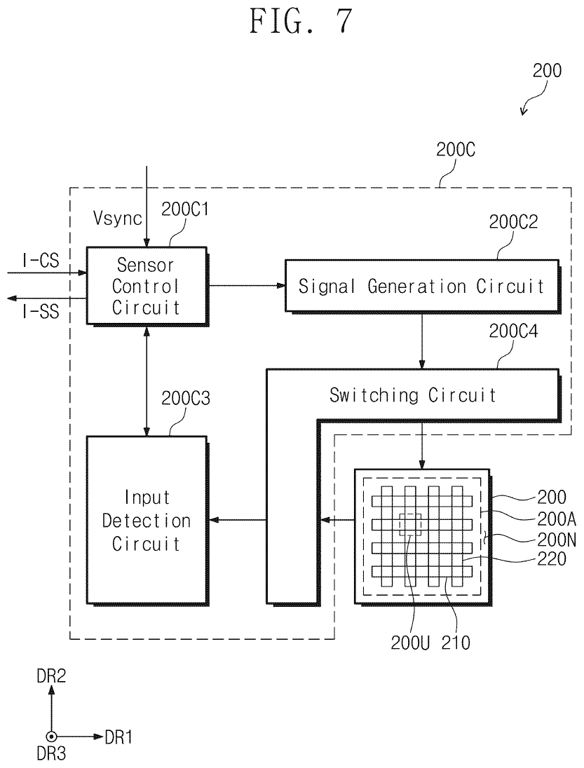

FIG. 7 is a block diagram of a sensor layer and a sensor driver, according to one or more embodiments of the present disclosure.

Referring to FIG. 7, an active area 200A and a peripheral area 200N may be defined in the sensor layer 200. The active area 200A may be an area activated depending on an electrical signal. For example, the active area 200A may be an area for sensing an input. The active area 200A may overlap with the active area 1000A (see, e.g., FIG. 1) of the electronic device 1000 (see, e.g., FIG. 1). The peripheral area 200N may surround the active area 200A. The peripheral area 200N may overlap with the peripheral area 1000NA (see, e.g., FIG. 1) of the electronic device 1000 (see, e.g., FIG. 1).

The sensor layer 200 may include the plurality of first electrodes 210 and the plurality of second electrodes 220. Each of the plurality of first electrodes 210 may extend in the first direction DR1. The plurality of first electrodes 210 may be arranged spaced from each other in the second direction DR2. Each of the plurality of second electrodes 220 may extend in the second direction DR2. The plurality of second electrodes 220 may be arranged spaced from each other in the first direction DR1.

The plurality of second electrodes 220 may intersect with the plurality of first electrodes 210 so as to be insulated (e.g., spaced apart) from each other. Each of the plurality of first electrodes 210 may have a bar shape or a stripe shape, and each of the plurality of second electrodes 220 may have a bar shape or a stripe shape. The plurality of first electrodes 210 and the plurality of second electrodes 220 having such the shape may improve sensing characteristics of a continuous linear input. However, the shape of each of the plurality of first electrodes 210 and the shape of each of the plurality of second electrodes 220 are not limited thereto.

The sensor driver 200C may receive the control signal I-CS from the main controller 1000C (see, e.g., FIG. 3) and may provide the coordinate signal I-SS to the main controller 1000C (see, e.g., FIG. 3).

The sensor driver 200C may include a sensor control circuit 200C1, a signal generation circuit 200C2, an input detection circuit 200C3, and a switching circuit 200C4. The sensor control circuit 200C1, the signal generation circuit 200C2, and the input detection circuit 200C3 may be implemented in a single chip. In one or more embodiments, a part of the sensor control circuit 200C1, the signal generation circuit 200C2, and the input detection circuit 200C3, and another part thereof may be implemented in different chips from each other.

The sensor control circuit 200C1 may control operations of the signal generation circuit 200C2 and the switching circuit 200C4, and may calculate coordinates of an external input from a driving signal received from the input detection circuit 200C3 or analyze information transmitted by the input device 2000 (see, e.g., FIG. 3) from the modulated signal received from the input detection circuit 200C3. The sensor control circuit 200C1 may define the active area 200A of the sensor layer 200 as a plurality of areas.

The sensor control circuit 200C1 may receive the vertical synchronization signal Vsync from the display driver 100C to synchronize the driving timing with the display layer 100 (see, e.g., FIG. 3). That is, the sensor driver 200C may operate in synchronization with the display driver 100C based on the vertical synchronization signal Vsync.

The signal generation circuit 200C2 may provide the sensor layer 200 with an output signal (or a driving signal) referred to as a “TX signal”. The signal generation circuit 200C2 may output an output signal matched with an operating mode to the sensor layer 200.

The input detection circuit 200C3 may convert an analog signal, which is referred to as an “RX signal (or a sensing signal)” received from the sensor layer 200, into a digital signal. The input detection circuit 200C3 may amplify the received analog signal and then may filter the amplified analog signal. For example, the input detection circuit 200C3 may convert the filtered signal into a digital signal.

The switching circuit 200C4 may selectively control an electrical connection relationship among the sensor layer 200, the signal generation circuit 200C2, and/or the input detection circuit 200C3 under the control of the sensor control circuit 200C1. Under the control of the sensor control circuit 200C1, the switching circuit 200C4 may connect one group among the plurality of first electrodes 210 and the plurality of second electrodes 220 to the signal generation circuit 200C2 or may connect the plurality of first electrodes 210 and the plurality of second electrodes 220 to the signal generation circuit 200C2. In one or more embodiments, the switching circuit 200C4 may connect one group among the plurality of first electrodes 210 and the plurality of second electrodes 220 or all of the plurality of first electrodes 210 and the plurality of second electrodes 220 to the input detection circuit 200C3.

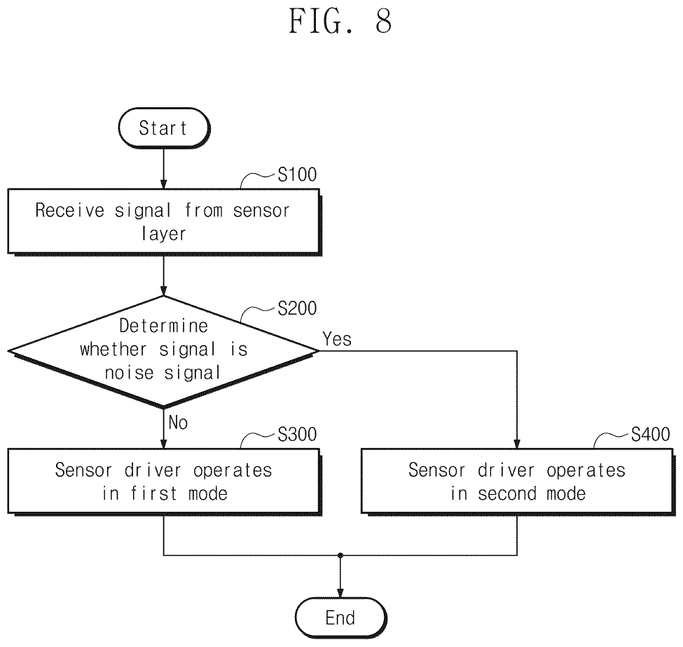

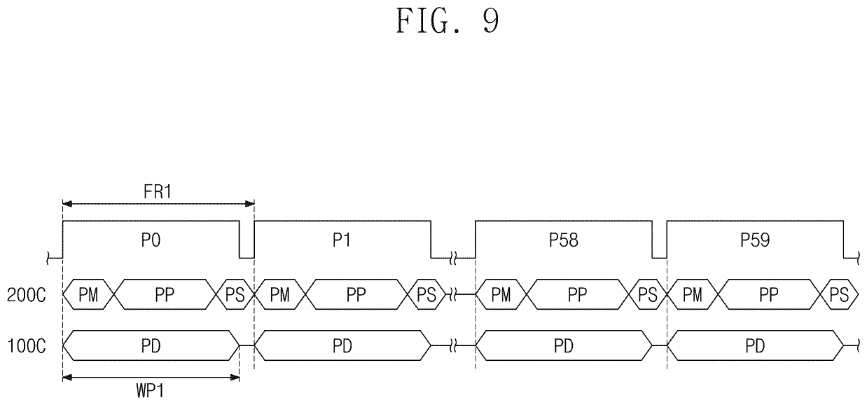

FIG. 8 is a flowchart illustrating a method of driving an electronic device, according to one or more embodiments of the present disclosure.

Referring to FIGS. 3 and 8, an electronic device operating method according to one or more embodiments of the present disclosure may include providing the electronic device 1000 including the display layer 100 for displaying the image IM (see, e.g., FIG. 1), the sensor layer 200 for receiving the downlink signal DLS from the input device 2000 (see, e.g., FIG. 1), the display driver 100C for driving the display layer 100, and the sensor driver 200C for driving the sensor layer 200, determining, by the sensor driver 200C, whether a signal received from the sensor layer 200 is a noise signal, which has the same or substantially the same frequency as the downlink signal DLS and of which the magnitude exceeds a predetermined magnitude, operating, by the sensor driver 200C, in a first mode when the signal is not the noise signal, and operating, by the sensor driver 200C, in a second mode when the signal is the noise signal.

The sensor layer 200 may receive a signal from outside the sensor layer 200 (S100).

The sensor layer 200 may sense the signal by using the plurality of first electrodes 210 (see, e.g., FIG. 7) and the plurality of second electrodes 220 (see, e.g., FIG. 7).

The sensor driver 200C may determine whether the signal is a noise signal (S200). The sensor driver 200C may determine the signal is a noise signal based on whether the signal has the same or substantially the same frequency as the downlink signal DLS and the magnitude of the signal exceeds a set magnitude (e.g., a preset or predetermined magnitude). For example, the noise signal may be generated by the data voltage Vdata (see, e.g., FIG. 6) of the display layer 100.

If the signal is not the noise signal, the sensor driver 200C may operate in the first mode (S300).

If the signal is the noise signal, the sensor driver 200C may operate in the second mode (S400).

FIG. 9 is a diagram illustrating operations of a display driver and a sensor driver in a first mode, according to one or more embodiments of the present disclosure.

Referring to FIGS. 3, 7, and 9, the display layer 100 may display the image IM (see, e.g., FIG. 1) in units of one frame period.

In a first mode, the display driver 100C may drive the display layer 100 with a first frame FR1 having a first operating frequency. The first operating frequency may be about 60 Hertz (Hz).

Each of the display driver 100C and the sensor driver 200C may operate in units of each of a plurality of periods P0, P1 to P58, and P59. FIG. 9 illustrates that the display driver 100C may operate the display layer 100 at about 60 Hz. In this case, each of the 60 periods P0 to P59 may operate as the first frame FR1.

The time corresponding to the first frame FR1 may be approximately 16.44 milliseconds (ms). That is, the time corresponding to each of the plurality of periods P0 to P59 may be approximately 16.44 ms. However, this is an example. An operation of the display driver 100C according to one or more embodiments of the present disclosure is not limited thereto. For example, the first operating frequency of the display layer 100 may be about 120 Hz. In this case, the time corresponding to each of the plurality of periods P0 to P59 may be approximately 8.33 ms, and the number of periods P0 to P59 may be about 120.

The first frame FR1 may be defined as a period from the rising edge of the vertical synchronization signal Vsync (see, e.g., FIG. 6) to the next rising edge thereof.

In the first mode, the sensor driver 200C may synchronize the driving timing with the display driver 100C based on the vertical synchronization signal Vsync. In this case, the display driver 100C and the sensor driver 200C may be referred to as “operating synchronously”. FIG. 9 illustrates that the display driver 100C and the sensor driver 200C operate in the first mode while being synchronized with each other. However, this is merely an example. An operation of the sensor driver 200C in the first mode according to one or more embodiments of the present disclosure is not limited thereto. For example, in the first mode, the sensor driver 200C may operate independently of the display driver 100C. In this case, the display driver 100C and the sensor driver 200C may be referred to as “operating asynchronously”.

The first frame FR1 may include a first write period WP1.

During the first write period WP1, the display driver 100C may operate in a data period PD. During the data period PD, the display driver 100C may provide the data voltage Vdata (see, e.g., FIG. 6) to the display layer 100.

During the first frame FR1, the sensor driver 200C may operate in a first sensing period PS, a second sensing period PM, and a third sensing period PP.

FIG. 9 illustrates that the display layer 100 may operate in the order of the second sensing period PM, the third sensing period PP, and the first sensing period PS during the first frame FR1. However, the operating order of the first sensing period PS, the second sensing period PM, and the third sensing period PP according to one or more embodiments of the present disclosure is not limited thereto. For example, during the first frame FR1, the display layer 100 may operate in the order of the first sensing period PS, the second sensing period PM, and the third sensing period PP.

During the first sensing period PS, the sensor layer 200 may sense the first input TC1 in a state where the plurality of first electrodes 210 and the plurality of second electrodes 220 are integrated into one electrode. In this case, the sensor layer 200 may be defined as operating in a self-touch method.

During the second sensing period PM, the sensor layer 200 may detect the first input TC1 by capacitively coupling the plurality of first electrodes 210 and the plurality of second electrodes 220. In this case, the sensor layer 200 may be defined as operating in a mutual touch method.

During the third sensing period PP, the sensor driver 200C may receive the downlink signal DLS from the input device 2000 (see, e.g., FIG. 1). The sensor driver 200C may calculate coordinate information of the second input TC2 by the input device 2000 based on the downlink signal DLS.

According to one or more embodiments of the present disclosure, when it is determined that a signal received from the sensor layer 200 is not a noise signal, the display driver 100C and the sensor driver 200C may operate in the first mode. During the first frame FR1, the sensor driver 200C may operate in the first sensing period PS, the second sensing period PM, and the third sensing period PP. In an environment without a noise signal, during the first frame FR1, the sensor driver 200C may detect the coordinate information of the first input TC1 by the user's body 3000 in the first sensing period PS and the second sensing period PM and may detect the coordinate information of the second input TC2 by the input device 2000 in the third sensing period PP. Accordingly, the electronic device 1000 having improved sensing reliability may be provided.

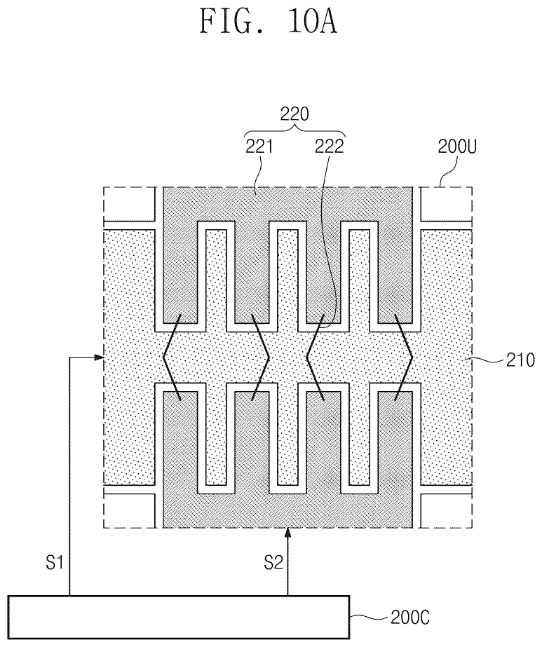

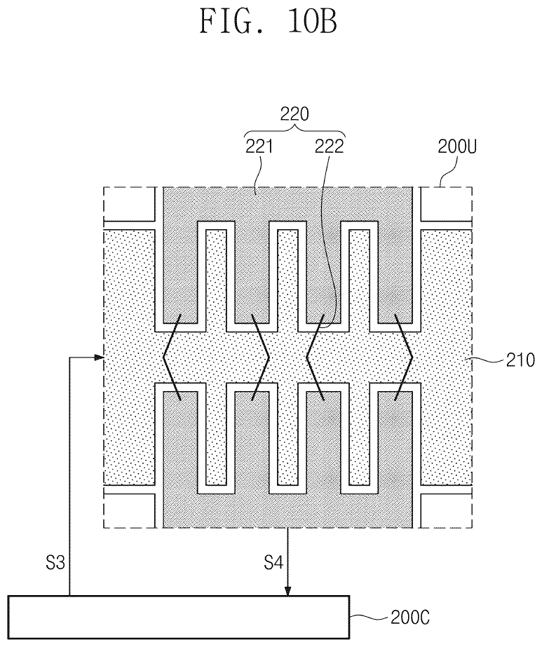

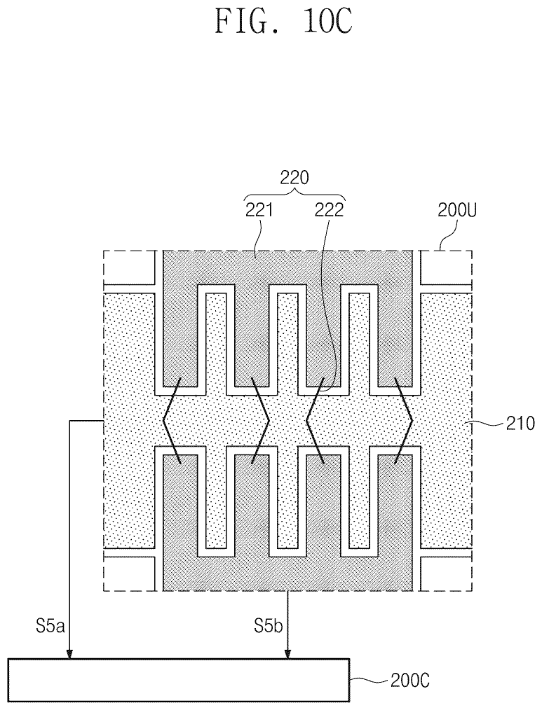

FIG. 10A is a diagram illustrating operations of a sensor layer and a sensor driver in a first sensing period, according to one or more embodiments of the present disclosure.

Referring to FIGS. 9 and 10A, a portion of the one first electrode 210 and a portion of the one second electrode 220 may be defined as one sensing unit 200U. FIG. 10A illustrates a portion of the sensor layer 200 operating in a self-touch method.

The second electrode 220 may include cross patterns 221 and bridge patterns 222 electrically connected to the cross patterns 221. The cross patterns 221 may be spaced from one another with the first electrode 210 interposed therebetween. The bridge patterns 222 may overlap with the first electrode 210, and the bridge patterns 222 may be intersected with the first electrode 210 in an insulation scheme.

The cross patterns 221 and the first electrode 210 may be disposed at the same layer (e.g., on or in the same layer), and the bridge patterns 222 may be disposed on a layer different from the cross patterns 221 and the first electrode 210. For example, the cross patterns 221 and the first electrode 210 may be included in the second conductive layer 204 (see, e.g., FIG. 5), and the bridge patterns 222 may be included in the first conductive layer 202 (see, e.g., FIG. 5). In this case, this structure may be referred to as a “bottom bridge structure”. However, one or more embodiments of the present disclosure is not limited thereto. For example, the cross patterns 221 and the first electrode 210 may be included in the first conductive layer 202 (see, e.g., FIG. 5), and the bridge patterns 222 may be included in the second conductive layer 204 (see, e.g., FIG. 5). This structure may be referred to as a “top bridge structure”.

Each of the cross patterns 221 and the first electrode 210 may have a mesh structure. In this case, an opening may be defined in each of the cross patterns 221 and the first electrode 210. However, the present disclosure is not limited thereto, and each of the cross patterns 221 and the first electrode 210 may be formed of a transparent common electrode.

The sensor driver 200C may transmit a first signal S1 and a second signal S2. In the self-touch method, the sensor driver 200C may provide the first signal S1 to the first electrode 210 and may provide the second signal S2 to the second electrode 220. In this case, the sensor driver 200C may detect touch coordinates of the first input TC1 from the amount of charge charged in a capacitor.

FIG. 10B is a diagram illustrating operations of a sensor layer and a sensor driver in a second sensing period, according to one or more embodiments of the present disclosure. In the description of FIG. 10B, the same reference numerals are assigned to the same components described with reference to FIG. 10A, and thus the descriptions thereof are omitted.

Referring to FIGS. 9 and 10B, the sensor driver 200C may transmit and receive an output signal S3 and a sensing signal S4. FIG. 10B illustrates a portion of the sensor layer 200 operating in a mutual touch method.

In a mutual touch method, the sensor driver 200C may provide the output signal S3 to the first electrode 210 and may receive the sensing signal S4 from the second electrode 220. That is, the first electrode 210 may act as a transmission electrode, and the second electrode 220 may act as a reception electrode. However, the present disclosure is not particularly limited thereto. For example, the first electrode 210 may act as the reception electrode, and the second electrode 220 may act as the transmission electrode. In this case, the sensor driver 200C may sense touch coordinates of the first input TC1 (see, e.g., FIG. 3) from a difference in the amount of charge between the first electrode 210 and the second electrode 220.

According to one or more embodiments of the present disclosure, to detect the first input TC1 (see, e.g., FIG. 3) in the one first frame FR1, the sensor layer 200 may use both the self-touch method and the mutual-touch method. The sensor driver 200C may sense coordinates of the first input TC1 based on the first sensing period PS and the second sensing period PM. The touch reliability of the first input TC1 (see, e.g., FIG. 3) may be improved. Accordingly, the electronic device 1000 (see, e.g., FIG. 1) having improved sensing reliability may be provided.

FIG. 10C is a diagram illustrating operations of a sensor layer and a sensor driver in a third sensing period, according to one or more embodiments of the present disclosure. In the description of FIG. 10C, the same reference numerals are assigned to the same components described with reference to FIG. 10A, and thus the descriptions thereof are omitted.

Referring to FIGS. 3, 9, and 10C, the downlink signal DLS (see, e.g., FIG. 3) may be provided from the input device 2000 to the electronic device 1000. Induction signals S5a and S5b may be provided to the sensor layer 200 by the downlink signal DLS. The first electrode 210 and the second electrode 220 may be used as reception electrodes for delivering the induction signals S5a and S5b induced from the input device 2000 to the sensor driver 200C, respectively.

During the third sensing period PP, the sensor driver 200C may receive the induction signals S5a and S5b. The sensor driver 200C may calculate coordinate information of the second input TC2 by the input device 2000 based on the induction signals S5a and S5b.

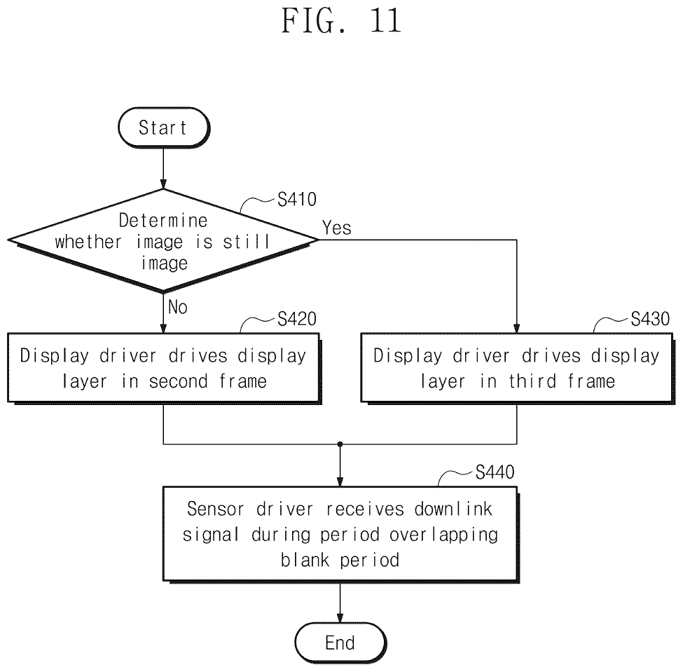

FIG. 11 is a flowchart illustrating a method of driving an electronic device in a second mode, according to one or more embodiments of the present disclosure.

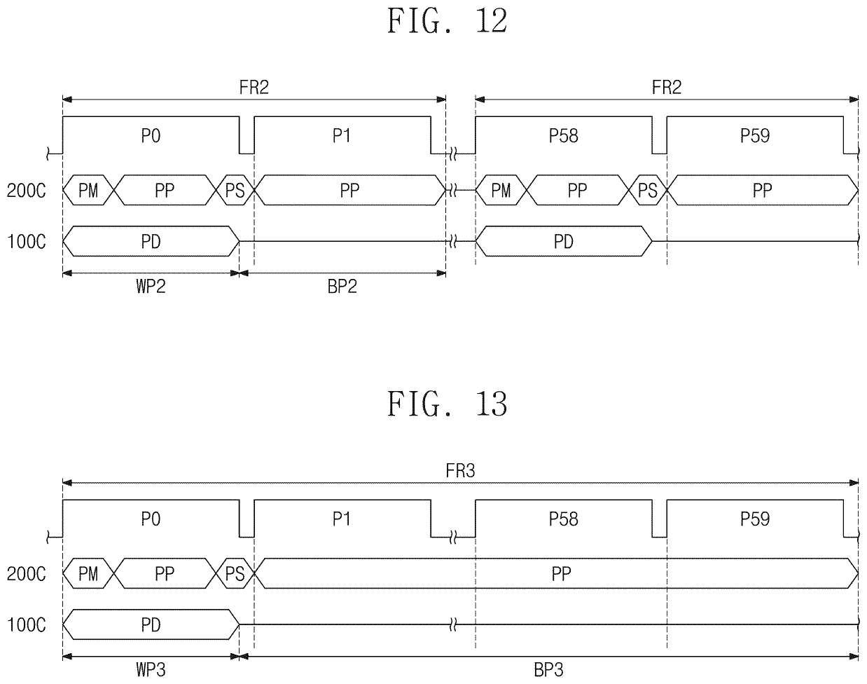

Referring to FIGS. 3, 8, and 11, the driving of the sensor driver 200C in a second mode may include driving, by the display driver 100C, the display layer 100 in a second frame FR2 (see, e.g., FIG. 12) having a second operating frequency, driving, by the display driver 100C, the display layer 100 in a third frame FR3 (see, e.g., FIG. 13) having a third operating frequency, and receiving, by the sensor driver 200C, the downlink signal DLS during a period overlapping with blank periods BP2 and BP3 (see, e.g., FIGS. 12 and 13).

The driving of the sensor driver 200C in a second mode may further include determining, by the display driver 100C, whether the image IM (see, e.g., FIG. 1) is a still image or a video (S410), and may further include driving, by the display driver 100C, the display layer 100 in the second frame FR2 (see, e.g., FIG. 12) when the image IM (see, e.g., FIG. 1) is a video (S420), and driving, by the display driver 100C, the display layer 100 in the third frame FR3 (see, e.g., FIG. 13) when the image IM (see, e.g., FIG. 1) is a still image (S430).

The sensor driver 200C may determine whether the signal received from the sensor layer 200 is a noise signal (S200). The sensor driver 200C may operate in the second mode when the signal is the noise signal (S400).

The display driver 100C may determine whether the image IM (see, e.g., FIG. 1) is a still image (S410).

When the image IM (see, e.g., FIG. 1) is not a still image, the display driver 100C may drive the display layer 100 in the second frame FR2 (see, e.g., FIG. 12) having a second operating frequency lower than the first operating frequency of the first frame FR1 (see, e.g., FIG. 9) (S420). For example, when the image IM (see, e.g., FIG. 1) is not a still image, the display driver 100C may determine the image IM (see, e.g., FIG. 1) is a video.

When the image IM (see, e.g., FIG. 1) is a still image, the display driver 100C may drive the display layer 100 in the third frame FR3 (see, e.g., FIG. 13) having a third operating frequency lower than the second operating frequency (S430).

In each of the second frame FR2 (see, e.g., FIG. 12) and the third frame FR3 (see, e.g., FIG. 13), the sensor driver 200C may receive the downlink signal DLS during a period overlapping with the blank period (S440). This will be described later.

FIG. 12 is a diagram illustrating operations of a display driver and a sensor driver in a second mode, according to one or more embodiments of the present disclosure. In the description of FIG. 12, the same reference numerals are assigned to the same components described with reference to FIG. 9, and thus the descriptions thereof are omitted.

Referring to FIGS. 3, 7, 11, and 12, the display layer 100 may display the image IM (see, e.g., FIG. 1) in units of one frame period.

When determining that the image IM (see, e.g., FIG. 1) is not a still image, the display driver 100C may drive the display layer 100 in the second frame FR2 having a second operating frequency, in the second mode. The second operating frequency may be lower than a first operating frequency of the first frame FR1 (see, e.g., FIG. 9). The second operating frequency may be about 30 Hz. However, this is an example. The second operating frequency of the display driver 100C according to one or more embodiments of the present disclosure is not limited thereto. For example, the second operating frequency may be a set frequency (e.g., a preset or predetermined frequency) between about 20 Hz and about 30 Hz.

Each of the display driver 100C and the sensor driver 200C may operate in units of each of the plurality of periods P0, P1 to P58, and P59. FIG. 12 illustrates that the display driver 100C may operate the display layer 100 at about 30 Hz. At this time, two adjacent periods among the 60 periods P0 to P59 may operate as the second frame FR2. For example, the first period P0 and the second period P1 may operate as one frame, and the 59th period P58 and the 60th period P59 may operate as one frame.

According to one or more embodiments of the present disclosure, the display driver 100C may operate in at least one period among the plurality of periods P0, P1 to P58, and P59 as one frame. The display driver 100C may adjust the operating frequency of the display layer 100 by using the plurality of periods P0, P1 to P58, and P59. The display layer 100 may operate at variable refresh rates. For example, when the operating frequency of the display layer 100 is lowered in a specific operating environment, the power consumption of the electronic device 1000 may be reduced.

The time corresponding to the second frame FR2 may be about 33.3 ms.

The second frame FR2 may be defined as a period from the rising edge of the vertical synchronization signal Vsync to the next rising edge thereof.

In the second mode, the sensor driver 200C may synchronize the driving timing with the display driver 100C based on the vertical synchronization signal Vsync. Unlike the first mode, in the second mode, the sensor driver 200C and the display driver 100C may be driven concurrently (e.g., synchronously).

The second frame FR2 may include a second write period WP2 and a second blank period BP2.

During the second write period WP2, the display driver 100C may operate in the data period PD. During the data period PD, the display driver 100C may provide the data voltage Vdata (see, e.g., FIG. 6) to the display layer 100. During the second frame FR2, the display layer 100 may display an image based on the data voltage Vdata (see, e.g., FIG. 6).

During the second blank period BP2, the display driver 100C may not perform any operations.

The data voltage Vdata (see, e.g., FIG. 6) provided to the display layer 100 may be delivered to the sensor layer 200 and may act as a noise signal. That is, the second blank period BP2 may be a period that is not affected by the noise signal.

During the second frame FR2, the sensor driver 200C may operate in the first sensing period PS, the second sensing period PM, and the third sensing period PP.

The sensor driver 200C may receive the downlink signal DLS by operating in the third sensing period PP during a period overlapping with the second blank period BP2.

For example, during the first period P0 of the second frame FR2, the sensor driver 200C may operate in the order of the second sensing period PM, the third sensing period PP, and the first sensing period PS. During the second period P1, which is the second period of the second frame FR2, the sensor driver 200C may operate in the third sensing period PP.

The sensor driver 200C may calculate coordinate information of the second input TC2 by the input device 2000 based on the downlink signal DLS.

According to one or more embodiments of the present disclosure, when it is determined that a signal received from the sensor layer 200 is a noise signal, the display driver 100C and the sensor driver 200C may operate in the second mode. During the second blank period BP2 of the second frame FR2, a noise signal may not be generated by the data voltage Vdata (see, e.g., FIG. 6). The sensor driver 200C may receive the downlink signal DLS during a period overlapping with the second blank period BP2. The sensing sensitivity of the downlink signal DLS may be improved. For this reason, a height at which the hovered input device 2000 is capable of being recognized may increase, and the latency for recognizing the input device 2000 may decrease. Accordingly, the electronic device 1000 having improved sensing reliability may be provided.

FIG. 13 is a diagram illustrating operations of a display driver and a sensor driver in a second mode, according to one or more embodiments of the present disclosure. In the description of FIG. 13, the same reference numerals are assigned to the same components described with reference to FIG. 9, and thus the descriptions thereof are omitted.

Referring to FIGS. 3, 7, 11, and 13, the display layer 100 may display the image IM (see, e.g., FIG. 1) in units of one frame period.

When determining that the image IM (see, e.g., FIG. 1) is a still image, the display driver 100C may drive the display layer 100 in the third frame FR3 having a third operating frequency, in the second mode. The third operating frequency may be lower than each of the first operating frequency of the first frame FR1 (see, e.g., FIG. 9) and the second operating frequency of the second frame FR2 (see, e.g., FIG. 12). The third operating frequency may be about 1 Hz. However, this is an example. The third operating frequency of the display driver 100C according to one or more embodiments of the present disclosure is not limited thereto. For example, the third operating frequency may be a set frequency (e.g., a preset or predetermined frequency) less than about 20 Hz.

Each of the display driver 100C and the sensor driver 200C may operate in units of each of the plurality of periods P0, P1 to P58, and P59. FIG. 13 illustrates that the display driver 100C may operate the display layer 100 at about 1 Hz. In this case, all the 60 periods P0 to P59 may operate as the third frame FR3. For example, the plurality of periods P0 to P59 may operate as one frame.

The display driver 100C may adjust the operating frequency of the display layer 100 by using the plurality of periods P0, P1 to P58, and P59. The display layer 100 may operate at variable refresh rates. For example, in the case of a still image, the display layer 100 may operate at a lower operating frequency than an operating frequency in the case of a video.

The time corresponding to the third frame FR3 may be about 1 s.

The third frame FR3 may be defined as a period from the rising edge of the vertical synchronization signal Vsync to the next rising edge thereof.

In the second mode, the sensor driver 200C may synchronize the driving timing with the display driver 100C based on the vertical synchronization signal Vsync.

The third frame FR3 may include a third write period WP3 and a third blank period BP3.

During the third write period WP3, the display driver 100C may operate in the data period PD. During the data period PD, the display driver 100C may provide the data voltage Vdata (see, e.g., FIG. 6) to the display layer 100. During the third frame FR3, the display layer 100 may display a video based on the data voltage Vdata (see, e.g., FIG. 6).

During the third blank period BP3, the display driver 100C may not perform any operations. The third blank period BP3 may be a period that is not affected by the noise signal.

During the third frame FR3, the sensor driver 200C may operate in the first sensing period PS, the second sensing period PM, and the third sensing period PP.

The sensor driver 200C may receive the downlink signal DLS by operating in the third sensing period PP during a period overlapping with the third blank period BP3.

For example, during the first period P0 of the third frame FR3, the sensor driver 200C may operate in the order of the second sensing period PM, the third sensing period PP, and the first sensing period PS. During the remaining periods P1 to P59 of the third frame FR3, the sensor driver 200C may operate in the third sensing period PP.

The sensor driver 200C may calculate coordinate information of the second input TC2 by the input device 2000 based on the downlink signal DLS.

According to one or more embodiments of the present disclosure, in a case where it is determined that a signal received from the sensor layer 200 is a noise signal, the display driver 100C and the sensor driver 200C may operate in the second mode. During the third blank period BP3 of the third frame FR3, a noise signal may not be generated by the data voltage Vdata (see, e.g., FIG. 6). The sensor driver 200C may receive the downlink signal DLS during a period overlapping with the third blank period BP3. The sensing sensitivity of the downlink signal DLS may be improved. For this reason, a height at which the hovered input device 2000 is capable of being recognized may increase, and the latency for recognizing the input device 2000 may decrease. Accordingly, the electronic device 1000 having improved sensing reliability may be provided.

Moreover, according to one or more embodiments of the present disclosure, in the case of a still image, the display layer 100 may operate at a lower operating frequency, and thus a blank period may be longer than the blank period in each of the first frame FR1 (see, e.g., FIG. 9) and the second frame FR2 (see, e.g., FIG. 12). The sensor driver 200C may receive the downlink signal DLS during a period overlapping with the third blank period BP3. Accordingly, the electronic device 1000 having improved sensing reliability may be provided.

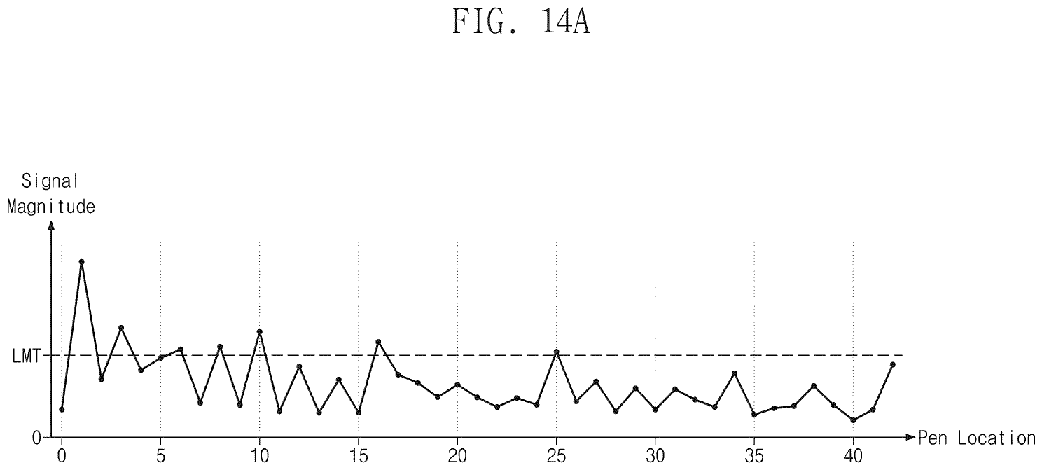

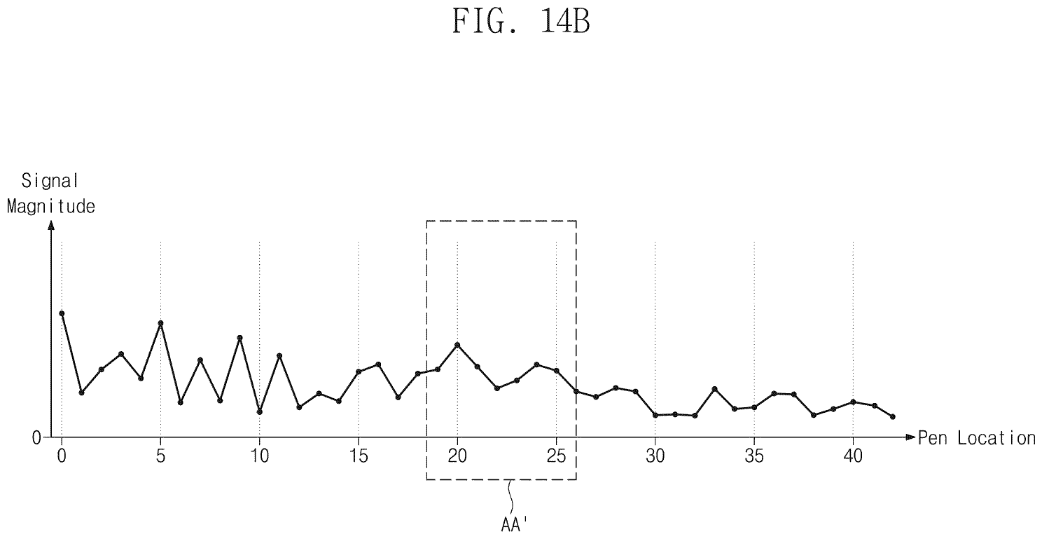

FIG. 14A is a graph showing a signal magnitude according to a pen location, according to one or more embodiments of the present disclosure.

Referring to FIGS. 5, 8, and 14A, a horizontal axis of graphs may indicate a location of the input device 2000. For example, the horizontal axis may indicate the location when the input device 2000 moves in the second direction DR2 while hovering about 5 millimeters (mm) from the electronic device 1000 in the third direction DR3.

The vertical axis may indicate a magnitude of a signal having the same frequency as the downlink signal DLS measured at a location of the sensor layer 200 corresponding to the location of the input device 2000.

The sensor layer 200 may detect the signal. The sensor driver 200C may receive a signal from the sensor layer 200 (S100).

The sensor driver 200C may determine whether the signal measured on the sensor layer 200 is a noise signal (S200). When the signal has the same or substantially the same frequency as the downlink signal DLS and the magnitude of the signal exceeds a threshold value LMT being a predetermined magnitude, the sensor driver 200C may determine the signal as a noise signal.

Because the signal, which has the same or substantially the same frequency as the downlink signal DLS and of which the magnitude exceeds the threshold value LMT, is monitored by the sensor layer 200, the sensor driver 200C may determine the signal as the noise signal.

The sensor driver 200C may operate in the second mode when the signal is the noise signal (S400).

FIG. 14B is a graph showing a signal magnitude according to a pen location, according to a comparative example of the present disclosure. In the description of FIG. 14B, the same reference numerals are assigned to the same components described with reference to FIG. 14A, and thus the descriptions thereof are omitted.

Referring to FIGS. 5 and 14B, in the case where an electronic device driving method according to one or more embodiments of the present disclosure is not applied, when a noise signal, which has the same or substantially the same frequency as the downlink signal DLS and of which the magnitude exceeds a set magnitude (e.g., a preset or predetermined magnitude), is generated, unlike one or more embodiments of the present disclosure, it may be difficult to recognize the downlink signal DLS having a sine wave provided from the input device 2000.

In other words, when receiving the downlink signal DLS of the input device 2000 at a first location AA′ from the input device 2000 in a noisy state, it may be difficult or impossible for the sensor driver 200C to recognize the input device 2000.

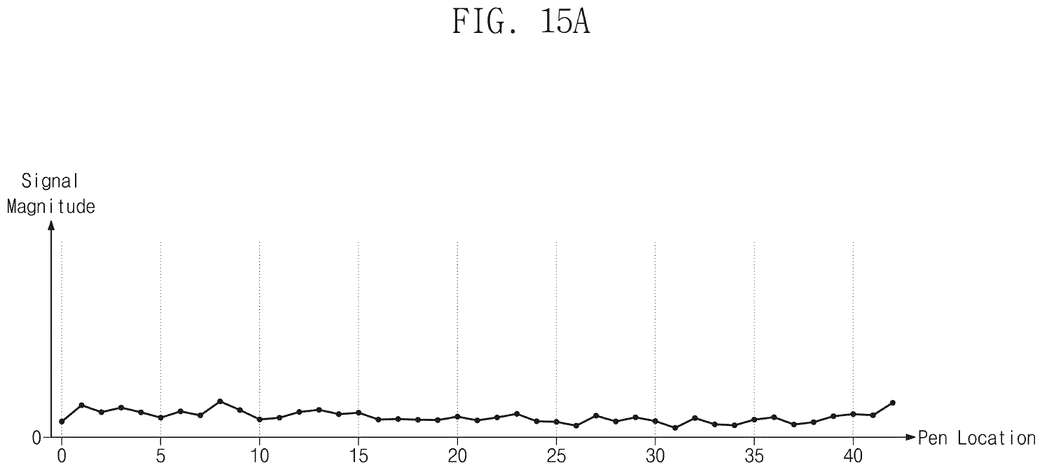

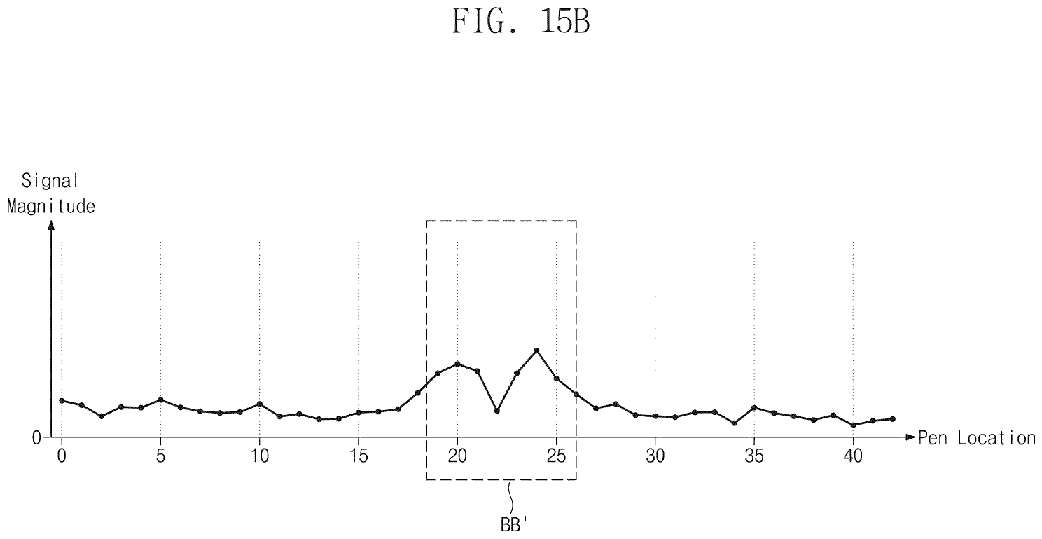

FIGS. 15A and 15B are graphs showing a signal magnitude according to a pen location, according to one or more embodiments of the present disclosure. In the description of FIGS. 15A and 15B, the same reference numerals are assigned to the same components described with reference to FIG. 14A, and thus the descriptions thereof are omitted.

Referring to FIGS. 5, 8, 15A, and 15B, the sensor layer 200 may detect a signal. The sensor driver 200C may receive a signal from the sensor layer 200 (S100).

The sensor driver 200C may determine whether the signal measured on the sensor layer 200 is a noise signal (S200). When the magnitude of the signal having the same or substantially the same frequency as the downlink signal DLS is smaller than or equal to a set magnitude (e.g., a preset or predetermined magnitude), the sensor driver 200C may determine that the signal is not a noise signal.

The sensor driver 200C may operate in a first mode when the signal is not a noise signal (S300). When receiving the downlink signal DLS from the input device 2000 at a second location BB′ while there is no noise, the sensor driver 200C may easily sense an input by the input device 2000.

According to one or more embodiments of the present disclosure, the display driver 100C and the sensor driver 200C may operate in the first mode. In an environment without a noise signal, during the first frame FR1 (see, e.g., FIG. 9), the sensor driver 200C may detect the coordinate information of the first input TC1 by the user's body 3000 in the first sensing period PS (see, e.g., FIG. 9) and the second sensing period PM (see, e.g., FIG. 9) and may detect the coordinate information of the second input TC2 by the input device 2000 in the third sensing period PP (see, e.g., FIG. 9). Accordingly, the electronic device 1000 having improved sensing reliability may be provided.

In one or more embodiments, the sensor driver 200C may operate in the second mode when the signal is the noise signal (S400). In the second mode, during the blank period BP2 or BP3 (see, e.g., FIGS. 12 and 13), a noise signal due to the data voltage Vdata (see, e.g., FIG. 6) may not be generated.

According to one or more embodiments of the present disclosure, in a case where the signal received from the sensor layer 200 is determined to be a noise signal, the sensor driver 200C may receive the downlink signal DLS during a period overlapping with the blank period BP2 or BP3 (see, e.g., FIG. 12 and FIG. 13) (S440 see, e.g., FIG. 11). The sensing sensitivity of the downlink signal DLS may be improved. For this reason, a height at which the hovered input device 2000 is capable of being recognized may increase, and the latency for recognizing the input device 2000 may decrease. Accordingly, the electronic device 1000 having improved sensing reliability may be provided.

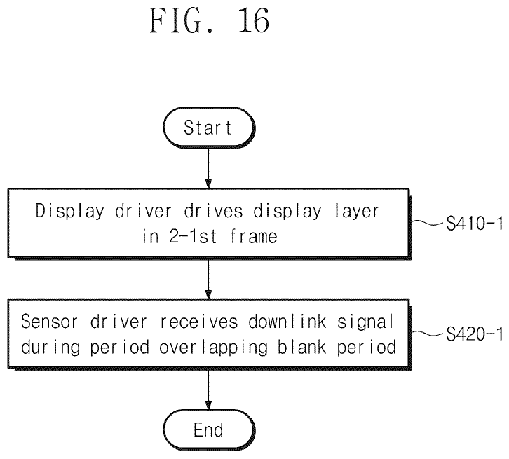

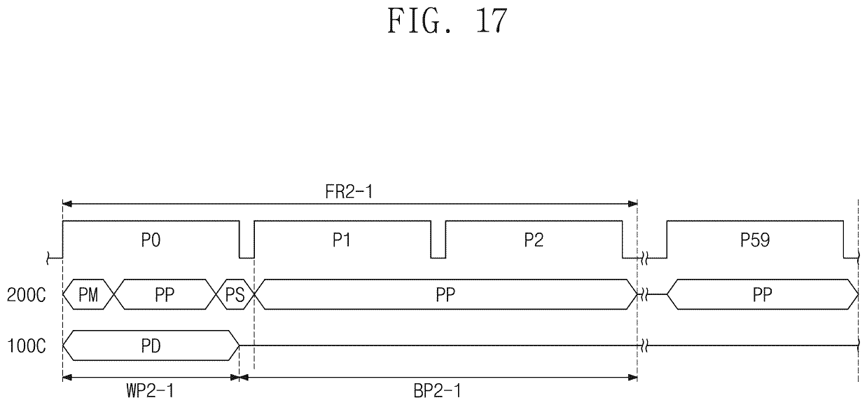

FIG. 16 is a flowchart illustrating a method of driving an electronic device in a second mode, according to one or more embodiments of the present disclosure. FIG. 17 is a diagram illustrating operations of a display driver and a sensor driver in a second mode, according to one or more embodiments of the present disclosure. In the description of FIG. 17, the same reference numerals are assigned to the same components described with reference to FIG. 9, and thus the descriptions thereof are omitted.

Referring to FIGS. 3, 8, 16, and 17, when a signal received from the sensor layer 200 is a noise signal, the sensor driver 200C may operate in a second mode (S400).

The display driver 100C may drive the display layer 100 in a 2-1st frame FR2-1 (S410-1).

In a second mode, the display driver 100C may drive the display layer 100 in the 2-1st frame FR2-1 having a 2-1st operating frequency. The 2-1st operating frequency may be lower than a first operating frequency of the first frame FR1 (see, e.g., FIG. 9). The 2-1st operating frequency may be about 20 Hz. However, this is merely an example. The 2-1st operating frequency of the display driver 100C according to one or more embodiments of the present disclosure is not limited thereto. For example, the 2-1st operating frequency may be a predetermined frequency between about 20 Hz and about 30 Hz.

Each of the display driver 100C and the sensor driver 200C may operate in units of each of the plurality of periods P0, P1, and P2 to P59. FIG. 17 illustrates that the display driver 100C may operate the display layer 100 at about 20 Hz. At this time, three adjacent periods among the 60 periods P0 to P59 may operate as the 2-1st frame FR2-1. For example, the first period P0, the second period P1, and the third period P2 may operate as one frame.

The time corresponding to the 2-1st frame FR2-1 may be about 48.9 ms.

The 2-1st frame FR2-1 may be defined as a period from the rising edge of the vertical synchronization signal Vsync (see, e.g., FIG. 6) to the next rising edge thereof.

In the second mode, the sensor driver 200C may synchronize the driving timing with the display driver 100C based on the vertical synchronization signal Vsync (see, e.g., FIG. 6). Unlike the first mode, in the second mode, the sensor driver 200C and the display driver 100C may be driven synchronously.

The 2-1st frame FR2-1 may include a 2-1st write period WP2-1 and a 2-1st blank period BP2-1.

During the 2-1st write period WP2-1, the display driver 100C may operate in the data period PD. During the data period PD, the display driver 100C may provide the data voltage Vdata (see, e.g., FIG. 6) to the display layer 100. During the 2-1st frame FR2-1, the display layer 100 may display the image IM (see, e.g., FIG. 1) based on the data voltage Vdata (see, e.g., FIG. 6).

During the 2-1st blank period BP2-1, the display driver 100C may not perform any operations.

The data voltage Vdata (see, e.g., FIG. 6) provided to the display layer 100 may be delivered to the sensor layer 200 and may operate as a noise signal. That is, the 2-1st blank period BP2-1 may be a period that is not affected by the noise signal.

During the 2-1st frame FR2-1, the sensor driver 200C may operate in the first sensing period PS, the second sensing period PM, and the third sensing period PP.

In the 2-1st frame FR2-1, the sensor driver 200C may receive the downlink signal DLS during a period overlapping with the 2-1st blank period BP2-1 (S420-1). That is, unlike the embodiments described in FIGS. 11 to 17, the sensor driver 200C may operate regardless of the type of the image IM (see, e.g., FIG. 1).

The sensor driver 200C may receive the downlink signal DLS by operating in the third sensing period PP during a period overlapping with the 2-1st blank period BP2-1. The sensor driver 200C may calculate coordinate information of the second input TC2 by the input device 2000 based on the downlink signal DLS.

According to one or more embodiments of the present disclosure, in a case where it is determined that a signal received from the sensor layer 200 is a noise signal, the display driver 100C and the sensor driver 200C may operate in the second mode. During the 2-1st blank period BP2-1 of the 2-1st frame FR2-1, a noise signal may not be generated by the data voltage Vdata (see, e.g., FIG. 6). The sensor driver 200C may receive the downlink signal DLS during a period overlapping with the 2-1st blank period BP2-1. The sensing sensitivity of the downlink signal DLS may be improved. For this reason, a height at which the hovered input device 2000 is capable of being recognized may increase, and the latency for recognizing the input device 2000 may decrease. Accordingly, the electronic device 1000 having improved sensing reliability may be provided.

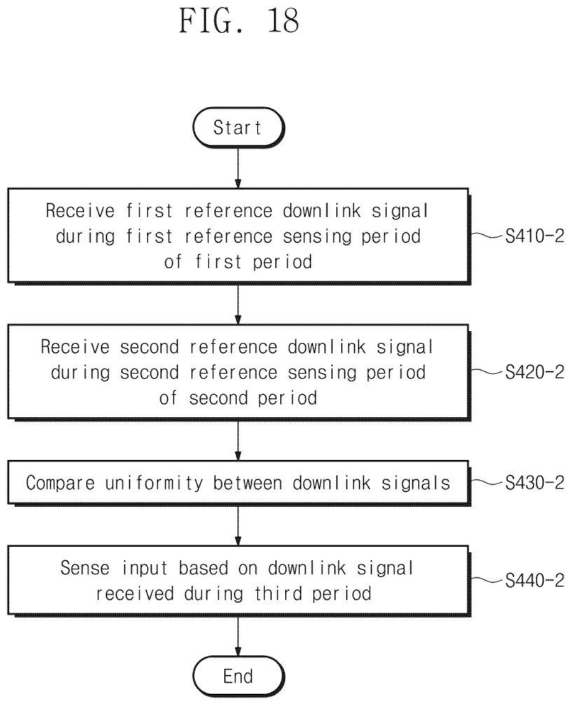

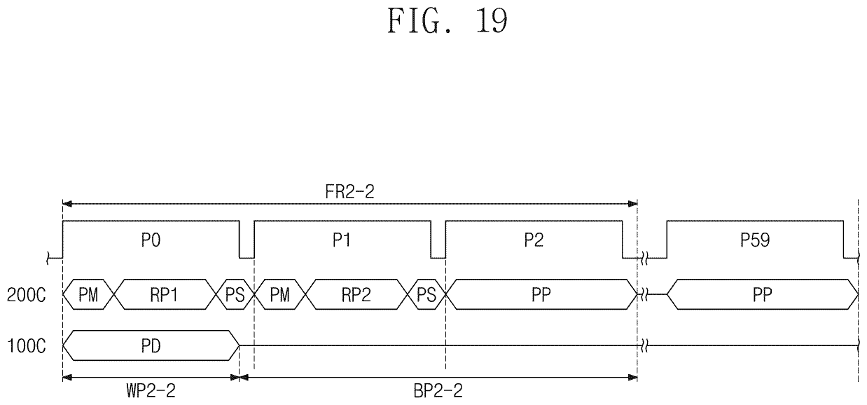

FIG. 18 is a flowchart illustrating a method of driving an electronic device in a second mode, according to one or more embodiments of the present disclosure. FIG. 19 is a diagram illustrating operations of a display driver and a sensor driver in a second mode, according to one or more embodiments of the present disclosure. In the description of FIG. 19, the same reference numerals are assigned to the same components described with reference to FIG. 9, and thus the descriptions thereof are omitted.

Referring to FIGS. 3, 8, 18, and 19, when a signal received from the sensor layer 200 is a noise signal, the sensor driver 200C may operate in a second mode (S400).

The display driver 100C may drive the display layer 100 in a 2-2nd frame FR2-2.

In a second mode, the display driver 100C may drive the display layer 100 with the 2-2nd frame FR2-2 having a 2-2nd operating frequency. The 2-2nd operating frequency may be lower than a first operating frequency of the first frame FR1 (see, e.g., FIG. 9). The 2-2nd operating frequency may be about 20 Hz. However, this is an example. The 2-2nd operating frequency of the display driver 100C according to one or more embodiments of the present disclosure is not limited thereto. For example, the 2-2nd operating frequency may have a frequency of about 20 Hz or less.

The time corresponding to the 2-2nd frame FR2-2 may be about 48.9 ms.

The 2-2nd frame FR2-2 may be defined as a period from the rising edge of the vertical synchronization signal Vsync (see, e.g., FIG. 6) to the next rising edge thereof.

The 2-2nd frame FR2-2 may include a 2-2nd write period WP2-2 and a 2-2nd blank period BP2-2.

During the 2-2nd write period WP2-2, the display driver 100C may operate in the data period PD. During the data period PD, the display driver 100C may provide the data voltage Vdata (see, e.g., FIG. 6) to the display layer 100. During the 2-2nd frame FR2-2, the display layer 100 may display the image IM (see, e.g., FIG. 1) based on the data voltage Vdata (see, e.g., FIG. 6).

During the 2-2nd blank period BP2-2, the display driver 100C may not perform any operations.

The sensor driver 200C may operate in units of each of the plurality of periods P0, P1, and P2 to P59.

During the first period P0, the sensor driver 200C may operate in the second sensing period PM, a first reference sensing period RP1, and the first sensing period PS. The downlink signal DLS may be received during the first reference sensing period RP1 of the first period P0 (S410-2).

During the second period P1 continuous with the first period P0, the sensor driver 200C may operate in the second sensing period PM, a second reference sensing period RP2, and the first sensing period PS. The downlink signal DLS may be received during the second reference sensing period RP2 of the second period P1 (S420-2).

The sensor driver 200C may compare uniformity between the downlink signal DLS received in the first reference sensing period RP1 and the downlink signal DLS received in the second reference sensing period RP2 (S430-2).

When the downlink signal DLS received in the first reference sensing period RP1 is substantially the same as the downlink signal DLS received in the second reference sensing period RP2, the sensor driver 200C may determine that the 2-2nd blank period BP2-2 is not entered.

The sensor driver 200C may infer whether there is a noise signal, based on whether the 2-2nd blank period BP2-2 is entered. For example, when the sensor driver 200C determines that the 2-2nd blank period BP2-2 is entered, the sensor driver 200C may determine that there is no noise signal. When the sensor driver 200C determines that the 2-2nd blank period BP2-2 is not entered, the sensor driver 200C may determine that there is a noise signal.

When the downlink signal DLS received in the first reference sensing period RP1 is different from the downlink signal DLS received in the second reference sensing period RP2, the sensor driver 200C may determine that the 2-2nd blank period BP2-2 is entered. For example, the uniformity of the downlink signal DLS measured in the second reference sensing period RP2 overlapping with the 2-2nd blank period BP2-2 may be improved rather than the uniformity of the downlink signal DLS measured in the first reference sensing period RP1 overlapping with the 2-2nd write period WP2-2.

During the third period P2 continuous with the first period P1, the sensor driver 200C may operate in the second sensing period PM, a third sensing period PP, and the first sensing period PS. The downlink signal DLS may be received during the third sensing period PP of the third period P2. When the sensor driver 200C determines that the 2-2nd blank period BP2-2 is entered, the sensor driver 200C may calculate coordinate information of the second input TC2 by the input device 2000 based on the downlink signal DLS received during the third sensing period PP.

In this case, the third period P2 may overlap with the 2-2nd blank period BP2-2.

According to one or more embodiments of the present disclosure, the sensor driver 200C may determine whether the 2-2nd blank period BP2-2 is entered, based on the downlink signals DLS received during the reference sensing periods RP1 and RP2. During the 2-2nd blank period BP2-2, a noise signal may not be generated by the data voltage Vdata (see, e.g., FIG. 6). The sensor driver 200C may receive the downlink signal DLS during a period substantially overlapping with the 2-2nd blank period BP2-2. The sensing sensitivity of the downlink signal DLS may be improved. For this reason, a height at which the hovered input device 2000 is capable of being recognized may increase, and the latency for recognizing the input device 2000 may decrease. Accordingly, the electronic device 1000 having improved sensing reliability may be provided.

Although one or more embodiments of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

As described above, when a signal received from a sensor layer is determined to be a noise signal, a display driver and a sensor driver may operate in a second mode. During a blank period of a second frame, a noise signal due to a data voltage may not be generated. During a period overlapping with the blank period, the sensor driver may receive a downlink signal. The sensing sensitivity of the downlink signal may be improved. For this reason, a height at which a hovered input device is capable of being recognized may increase, and the latency for recognizing the input device may decrease. Accordingly, it is possible to provide the electronic device with improved sensing reliability.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. An electronic device comprising:
a display layer configured to display an image;
a sensor layer on the display layer and configured to receive a downlink signal from an input device;
a display driver configured to drive the display layer; and
a sensor driver configured to control the sensor layer and to operate in a first mode and a second mode different from the first mode,
wherein in the first mode, the display driver is configured to drive the display layer in a first frame having a first operating frequency,
wherein in the second mode, the display driver is configured to drive the display layer in a second frame having a second operating frequency lower than the first operating frequency,
wherein the second frame comprises a first write period and a first blank period, and
wherein in the second mode, the sensor driver is configured to receive the downlink signal during a period overlapping with the first blank period.

2. The electronic device of claim 1, wherein in response to the sensor layer sensing a noise signal, the sensor driver is configured to operate in the second mode.

3. The electronic device of claim 2, wherein in response to receiving a signal from the sensor layer having a frequency about the same as the downlink signal and a magnitude exceeding a set magnitude, the sensor driver is configured to identify the signal as the noise signal.

4. The electronic device of claim 1, wherein the sensor layer is configured to sense coordinates of an input by the input device through the downlink signal.

5. The electronic device of claim 1, wherein the input device is an active pen.

6. The electronic device of claim 1, wherein the display driver is configured to provide a data voltage to the display layer during the first write period.

7. The electronic device of claim 1, wherein the display driver is configured to generate a vertical synchronization signal, and
wherein in the second mode, the sensor driver is configured to operate in synchronization with the display driver based on the vertical synchronization signal.

8. The electronic device of claim 1, wherein in the second mode, the display driver further is configured to drive the display layer in a third frame having a third operating frequency lower than the second operating frequency.

9. The electronic device of claim 8, wherein in the second mode, the display driver is configured to drive the display layer in the third frame in response to the image being a still image, and the display driver is configured to drive the display layer in the second frame in response to the image being a video.

10. The electronic device of claim 1, wherein the sensor driver is configured to:
compare uniformity between the downlink signal received during a first period and the downlink signal received during a second period continuous with the first period, and sense an input by the input device based on another downlink signal received during a third period continuous with the second period in response to the uniformity of the downlink signal received during the first period being different from the uniformity of the downlink signal received during the second period, and
wherein the third period overlaps with the first blank period.

11. A method of driving an electronic device, the method comprising:
providing the electronic device comprising a display layer configured to display an image, a sensor layer configured to receive a downlink signal from an input device, a display driver configured to drive the display layer, and a sensor driver configured to drive the sensor layer;
determining, by the sensor driver, whether a signal received from the sensor layer is a noise signal that has a same frequency as the downlink signal and has a magnitude exceeding a set magnitude;
operating, by the sensor driver, in a first mode in response to the signal not being the noise signal; and
operating, by the sensor driver, in a second mode in response to the signal being the noise signal,
wherein the operating, by the sensor driver, in the first mode comprises:
driving, by the display driver, the display layer in a first frame having a first operating frequency, and
wherein the operating, by the sensor driver, in the second mode comprises:
driving, by the display driver, the display layer in a second frame, which has a second operating frequency lower than the first operating frequency and which comprises a first write period and a first blank period; and
receiving, by the sensor driver, the downlink signal during a period overlapping with the first blank period.

12. The method of claim 11, wherein the operating, by the sensor driver, in the second mode comprises:
sensing, by the sensor layer, coordinates of an input by the input device through the downlink signal.

13. The method of claim 11, wherein the input device is an active pen.

14. The method of claim 11, wherein the display driver is configured to generate a vertical synchronization signal.

15. The method of claim 14, wherein the operating, by the sensor driver, in the second mode further comprises:
operating, by the sensor driver, in synchronization with the display driver based on the vertical synchronization signal.

16. The method of claim 11, wherein the operating, by the sensor driver, in the second mode further comprises driving, by the display driver, the display layer in a third frame having a third operating frequency lower than the second operating frequency.

17. The method of claim 16, wherein the operating, by the sensor driver, in the second mode further comprises:
determining whether the image is a still image or a video.

18. The method of claim 17, wherein the operating, by the sensor driver, in the second mode further comprises:
in response to the image being the still image, driving, by the display driver, the display layer in the third frame; and
in response to the image being the video, driving, by the display driver, the display layer in the second frame.

19. The method of claim 11, wherein the operating, by the sensor driver, in the second mode further comprises:
comparing, by the sensor driver, uniformity between the downlink signal received during a first period and the downlink signal received during a second period continuous with the first period.

20. The method of claim 19, wherein the operating, by the sensor driver, in the second mode further comprises:
sensing an input by the input device based on another downlink signal received during a third period continuous with the second period in response to the uniformity of the downlink signal received during the first period being different from the uniformity of the downlink signal received during the second period, and
wherein the third period overlaps with the first blank period.
